(19) United States
(12) Patent Application Publication
(10) Pub. No.: US 2025/0274699 A1
(43) Pub. Date: Aug. 28, 2025

(54) ELECTRONIC DEVICE ADJUSTING FILTERING CIRCUIT, NOISE PROCESSING CIRCUIT, AND OPERATING METHOD THEREOF

(71) Applicant: Samsung Electronics Co., Ltd., Suwon-si (KR)

(72) Inventors: Andrey Zobenko, Suwon-si (KR); Youngseok Kim, Suwon-si (KR); Keunsang Lee, Suwon-si (KR)

(21) Appl. No.: 19/054,992

(22) Filed: Feb. 17, 2025

(30) Foreign Application Priority Data
Feb. 23, 2024 (KR) 10-2024-0026750
Apr. 19, 2024 (KR) 10-2024-0052815

(51) Int. Cl. H04R 1/22; H04R 3/00

(52) U.S. Cl. CPC H04R 1/222; H04R 3/005

(57) ABSTRACT

An electronic device includes a first microphone configured to receive a noise signal, a second microphone configured to receive an error signal and forming a primary path from the first microphone, a filtering circuit configured to generate an electrical offset signal for offsetting at least one of the noise signal and the error signal, a memory in which reference secondary paths and pre-set optimal filter set value sets corresponding to the reference secondary paths, respectively, are stored, and a noise processing circuit configured to adjust a set value of the filtering circuit. The noise processing circuit is configured to estimate an object secondary path between an inner speaker outputting an acoustic offset signal corresponding to the electrical offset signal, and the second microphone, select one of the optimal filter set value sets by comparing the estimated object secondary path with each of the reference secondary paths, and change, based on the selected optimal filter set value set, the set value of the filtering circuit.

### CROSS-REFERENCE TO RELATED APPLICATION

This application is based on and claims priority under 35 U.S.C. § 119 to Korean Patent Application Nos. 10-2024-0026750, filed on Feb. 23, 2024, and 10-2024-0052815, filed on Apr. 19, 2024, in the Korean Intellectual Property Office, the disclosures of which are incorporated by reference herein in their entirety.

### BACKGROUND

Aspects of the inventive concept relate to an electronic device, and more particularly, to a noise processing circuit adjusting a filtering circuit by using an optimal filter set value set, an electronic device including the noise processing circuit, and an operating method of the noise processing circuit.

An electronic device may output a received sound signal (for example, audio data). For example, the electronic device may include an ear-wearable device, such as earphones, headphones, etc. worn on the ears of a user. The electronic device (for example, an ear-wearable device) may be connected to another electronic device (for example, a cellular phone), and the electronic device may output a sound signal received from the other electronic device.

In order to remove a noise signal input from the outside of the electronic device and noise in the electronic device, the need for noise cancellation technologies is on the rise. For example, active noise cancellation (ANC) technology may be used to reduce sound that a user does not wish to hear.

Recently, the use of ear-wearable devices such as earphones, etc., has greatly increased, and thus, techniques for removing noise and improving noise removal performance are desirable.

### SUMMARY

Aspects of the inventive concept provide a noise processing circuit for adaptively improving noise cancelling performance for a separate user by selecting an optimal filter set value set for optimizing a reference secondary path which is the most similar to an estimated secondary path from among various reference secondary paths and by adjusting filter coefficients of a filtering circuit based on the selected optimal filter set value set, and an electronic device including the noise processing circuit.

According to an aspect of the inventive concept, an electronic device includes a first microphone configured to receive a noise signal, a second microphone configured to receive an error signal and forming a primary path from the first microphone, a filtering circuit configured to generate an electrical offset signal for offsetting at least one of the noise signal and the error signal, a memory in which reference secondary paths and pre-set optimal filter set value sets corresponding to the reference secondary paths, respectively, are stored, and a noise processing circuit configured to adjust a set value of the filtering circuit. The noise processing circuit is configured to estimate an object secondary path between an inner speaker outputting an acoustic offset signal corresponding to the electrical offset signal, and the second microphone, select one of the optimal filter set value sets by comparing the estimated object secondary path with each of the reference secondary paths, and change, based on the selected optimal filter set value set, the set value of the filtering circuit.

According to another aspect of the inventive concept, a noise processing circuit includes a path estimator configured to receive an inner sound signal transmitted to an inner speaker and an error signal transmitted from an error microphone and estimating, based on the inner sound signal and the error signal, an object transmission path between the inner speaker and the error microphone, and a set value adjustor configured to compare the estimated object transmission path with each of a plurality of reference transmission paths, select, based on a result of the comparison, one filter set value set from among pre-set filter set value sets corresponding to the reference transmission paths, respectively, and output a control signal for adjusting, based on the selected filter set value set, a set value of a filtering circuit.

According to another aspect of the inventive concept, an operating method of a noise processing circuit includes receiving an inner sound signal transmitted through an inner speaker and an error signal transmitted from an error microphone, estimating, based on the inner sound signal and the error signal, an object transmission path between the inner speaker and the error microphone, comparing the estimated object transmission path with each of a plurality of reference transmission paths stored in a memory, selecting, based on a result of the comparison, one filter set value set from among pre-set filter set value sets respectively corresponding to the reference transmission paths, and adjusting, based on the selected filter set value set, a set value of a filtering circuit.

### BRIEF DESCRIPTION OF THE DRAWINGS

Embodiments will be more clearly understood from the following detailed description taken in conjunction with the accompanying drawings in which:

FIG. 1 is a view for describing an electronic device according to an embodiment;

FIG. 2 is a view for describing an ear-wearable device according to an embodiment;

FIG. 3 is a view for describing a filtering circuit according to an embodiment;

FIG. 4 is a view for describing an operation of a noise processing circuit according to an embodiment;

FIG. 5 is a block diagram of a noise processing circuit according to an embodiment;

FIG. 6 is a view for describing a method of selecting an optimal filter set value set, according to an embodiment;

FIG. 7A is a graph showing a frequency response amplitude of a plurality of reference secondary paths;

FIG. 7B is a graph showing a frequency response amplitude of an object secondary path;

FIG. 8A is a view for describing a method of obtaining a deviation, according to an embodiment;

FIG. 8B is a view for describing a method of obtaining a deviation, according to an embodiment;

FIG. 9 is a flowchart of an operating method of a noise processing circuit, according to an embodiment;

FIG. 10 is a flowchart of a method of obtaining a reference secondary path and an optimal filter set value set, according to an embodiment;

FIG. 11 is a view for describing a reference secondary path according to an embodiment;

FIG. 12 is a view for describing a sample secondary path according to an embodiment;

FIG. 13 is a view for describing a method of clustering sample secondary paths, according to an embodiment;

FIG. 14 is a view for describing a first filtering circuit according to an embodiment;

FIG. 15 is a view for describing a method of generating a first optimal filtering set value, according to an embodiment;

FIG. 16 is a view for describing a second filtering circuit according to an embodiment;

FIG. 17 is a view for describing a method of generating a second optimal filtering set value, according to an embodiment;

FIG. 18 is a view for describing a second fitness function according to an embodiment; and

FIG. 19 is a block diagram of an electronic device according to an embodiment.

### DETAILED DESCRIPTION OF THE EMBODIMENTS

Hereinafter, embodiments will be described in detail with reference to the accompanying drawings. For the same elements in the drawings, the same reference numerals are used, and the same descriptions are not repeated.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first”) in a particular claim may be described elsewhere with a different ordinal number (e.g., “second”) in the specification or another claim.

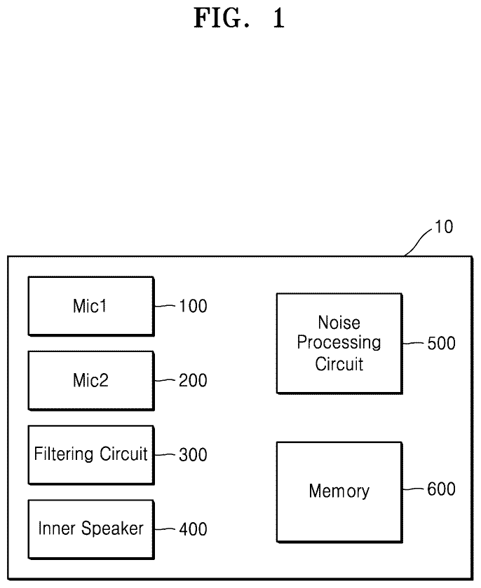

FIG. 1 is a view for describing an electronic device 10 according to an embodiment.

Referring to FIG. 1, the electronic device 10 may include a first microphone 100, a second microphone 200, a filtering circuit 300, an inner speaker 400, and a noise processing circuit 500. According to an embodiment, the electronic device 10 may further include a memory 600. According to an embodiment, the electronic device 10 may further include other general-purpose components in addition to the components illustrated in FIG. 1.

The electronic device 10 may be or include an audio device outputting a sound signal. The audio device may be or include a wearable device, such as a wired earphone, a wireless earphone, a headphone, etc. However, the electronic device 10 is not necessarily limited thereto and may include at least one of a smartphone, a tablet personal computer (PC), a mobile phone, a display phone, an electronic book (e-book) reader, a desktop PC, a laptop PC, a netbook computer, a workstation, a server, a personal digital assistant (PDA), a portable multimedia player (PMP), an MPEG audio layer 3 (MP3) player, a mobile medical device, a camera, or a wearable device. Furthermore, the electronic device 10 may include a smart home appliance. The smart home appliance may include, for example, at least one of a television, a digital video disk (DVD) player, an audio player, a refrigerator, an air-conditioner, a cleaning device, an oven, a microwave oven, a laundry machine, an air cleaner, a set-top box, a home automation control panel, a security control panel, a TV box, a game console, an electronic dictionary, an electronic key, a camcorder, or an electronic frame. Also, the electronic device 10 may include various medical devices. The medical devices may include, for example, various portable medical measuring devices (a blood sugar measuring device, a heart rate measuring device, a blood pressure measuring device, a body temperature measuring device, etc.), a magnetic resonance angiography (MRA) device, a magnetic resonance imaging (MRI) device, a computed tomography (CT) device, a camera, an ultrasonic device, etc.

The first microphone 100 may receive a noise signal. For example, the first microphone 100 may receive the noise signal from the outside of the electronic device 10. The first microphone 100 may receive the noise signal to adjust a sound signal. For example, while the first microphone 100 is being worn on cars of a user, the first microphone 100 may receive an external noise signal generated in an external ambient environment. For example, the noise signal may include a digital signal converted from an analog signal by an analog-digital converter (ADC). The first microphone 100 may be used to remove the external noise signal. The first microphone 100 may transmit the external noise signal to the filtering circuit 300. The first microphone 100 may also be referred to as a reference microphone.

The second microphone 200 may receive an error signal. The error signal may be the difference between a noise signal transmitted through a primary path and an offset signal transmitted through a secondary path. For example, a larger error signal may indicate that the offset signal is not 180 degrees out of phase with or is further from being 180 degrees out of phase with the noise signal and therefore is not optimally canceling the noise signal, and a smaller or zero error signal may indicate that the offset signal is closer to 180 degrees out of phase with the noise signal and therefore may be optimally canceling the noise signal. The primary path may refer to a transmission function from the first microphone 100 to the second microphone 200, and the second path may refer to a transmission function from the inner speaker 400 to the second microphone 200. The second microphone 200 may be used to remove the error signal (e.g., reduce to the error signal to have a zero value). The second microphone 200 may transmit the error signal to the filtering circuit 300. The second microphone 200 may also be referred to as an error microphone.

The first microphone 100 and the second microphone 200 may be arranged in the electronic device 10 to be apart from each other. For example, when the electronic device 10 is worn on a user, the second microphone 200 may be arranged in the electronic device 10 to be more adjacent to the eardrum of the user than the first microphone 100 is.

The filtering circuit 300 may generate the offset signal. The filtering circuit 300 may perform a filtering process by receiving the noise signal and the error signal and may generate the offset signal. For example, the filtering circuit 300 may perform a filtering operation, such as spectrum modeling (for example, low band pass filtering, high band pass filtering, band pass filtering, etc.), resonance removal, impedance matching, gain control, etc.

The filtering circuit 300 may generate or adjust the offset signal for reducing or removing at least one of the noise signal and the error signal. According to an embodiment, the filtering circuit 300 may include a first filtering circuit and a second filtering circuit. The first filtering circuit may generate a first offset signal for reducing or removing the error signal. The first filtering circuit may receive the error signal and generate the first offset signal. The first filtering circuit may generate the first offset signal to at least partially remove the error signal. For example, the first filtering circuit may also be referred to as a feedback filter, a feedback equalizer, etc.

The second filtering circuit may generate a second offset signal for offsetting the noise signal. The second filtering circuit may receive the noise signal and generate the second offset signal. The second filtering circuit may generate the second offset signal to at least partially remove the noise signal. For example, the second filtering circuit may also be referred to as a feedforward filter, a feedforward equalizer, etc.

The electronic device 10 may include the inner speaker 400. The inner speaker 400 may output the offset signal. The inner speaker 400 may output the offset signal received from the filtering circuit 300. For example, the inner speaker 400 may output the offset signal in which the first offset signal generated by the first filtering circuit and the second offset signal generated by the second filtering circuit are combined. The first offset signal and the second offset signal may each be an electrical signal. The offset signal output by the inner speaker 400 may be an acoustic signal, converted and generated from the combined electrical offset signals.

The noise processing circuit 500 may adjust a set value of the filtering circuit 300. The filtering circuit 300 may be designed or adjusted based on set values. Adjusting the set value of the filtering circuit 300 may including changing a filter coefficient of the filtering circuit 300. For example, even when the same noise signal is transmitted to the filtering circuit 300, a different offset signal may be generated when the set value of the filtering circuit 300 is changed. The noise processing circuit 500 may output a control signal for adjusting the set value of the filtering circuit 300.

The secondary path may be different according to a user. Each user may have a different ear shape and an ear length, which may vary. The ear shape, the ear length, etc. may affect the secondary path. Because the secondary path may be different for each user, it is important to adjust the filtering circuit according to each user. For example, when a user wears the electronic device 10, the noise processing circuit 500 may adjust the set value of the filtering circuit 300. However, the disclosure is not limited thereto, and the noise processing circuit 500 may adjust the set value of the filtering circuit 300 at various time points. The noise processing circuit 500 may estimate the secondary path and may adjust the set value of the filtering circuit 300 based on the secondary path.

According to an embodiment, the noise processing circuit 500 may estimate the secondary path. The secondary path may correspond to a transmission function between the inner speaker 400 and the second microphone 200 and may also be referred to as a transmission path. For example, the term “secondary path” may be used to refer to a transmission function between the inner speaker 400 and the second microphone 200. As described herein, estimating the secondary path may refer to estimating the transmission function between the inner speaker 400 and the second microphone 200. Also, estimating the secondary path may include calculating an amplitude of a frequency response between the inner speaker 400 and the second microphone 200. For example, the noise processing circuit 500 may estimate the secondary path by using an inner sound source of the electronic device 10. For example, the electronic device 10 may further include a white noise generator and the noise processing circuit 500 may estimate the secondary path based on the white noise generated by the white noise generator. The secondary path estimated in the electronic device 10 by the noise processing circuit 500 may be referred to as an object secondary path.

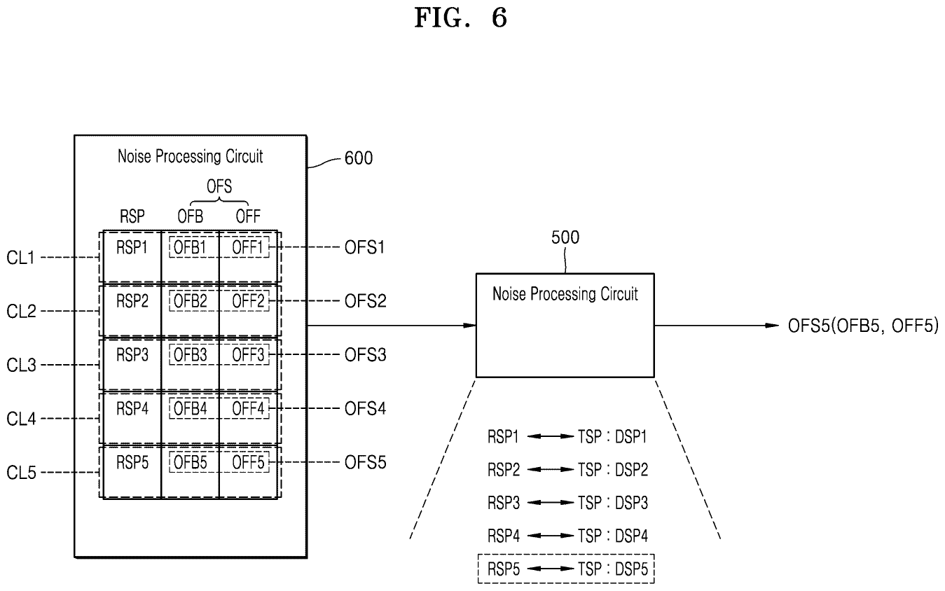

The noise processing circuit 500 may change the set value of the filtering circuit 300. According to an embodiment, the noise processing circuit 500 may compare the object secondary path (e.g., an object transmission function) with reference secondary paths (e.g., reference transmission functions). The reference secondary paths may be stored in the memory 600. The reference secondary paths may be pre-stored or pre-set in the memory 600. The memory 600 may store a plurality of reference secondary paths. The reference secondary path may refer to the secondary paths stored in the memory 600, so that each reference secondary path may be one reference transmission function, and a plurality of different reference secondary paths which each correspond to a respective reference transmission function are stored in the memory 600. Aspects with respect to the reference secondary path will be described in detail below with reference to FIG. 6.

The noise processing circuit 500 may compare the object secondary path with each of the plurality of reference secondary paths. The noise processing circuit 500 may read the reference secondary paths stored in the memory 600 and compare each of the reference secondary paths with the object secondary path. For example, when a first reference secondary path, a second reference secondary path, and a third reference secondary path are stored in the memory 600, the noise processing circuit 500 may compare the object secondary path with the first reference secondary path, may compare the object secondary path with the second reference secondary path, and may compare the object secondary path with the third reference secondary path.

Based on a comparison result of comparing the object secondary path with each of the reference secondary paths (e.g., a closest match), the noise processing circuit 500 may select one of a plurality of pre-set, optimal filter set value sets. The memory 600 may store the plurality of reference secondary paths and the plurality of optimal filter set value sets corresponding to the plurality of reference secondary paths, respectively. The optimal filter set value sets may correspond to the plurality of reference secondary paths, respectively, and the selected optimal filter set value set may optimize the corresponding reference secondary path. Aspects with respect to the optimal filter set value set will be described in detail with reference to FIG. 6.

For example, the first reference secondary path, the second reference secondary path, and the third reference secondary path may be stored in the memory 600. A first optimal filter set value set corresponding to the first reference secondary path, a second optimal filter set value set corresponding to the second reference secondary path, and a third optimal filter set value set corresponding to the third reference secondary path may be stored in the memory 600. However, the disclosure is not necessarily limited thereto, and various numbers of reference secondary paths and optimal filter set value sets may be stored in the memory 600.

The noise processing circuit 500 may search for the reference secondary path the most similar to the object secondary path and may select the optimal filter set value set corresponding to the reference secondary path the most similar to the object secondary path. The noise processing circuit 500 may change the set value of the filtering circuit 300, based on the selected optimal filter set value set.

According to an embodiment, each optimal filter set value set may include a first optimal filtering set value and a second optimal filtering set value. The first optimal filtering set value may be applied to the first filtering circuit and may indicate feedback filter coefficients (e.g., a first subset of values of the optimal filter set value set corresponding to the feedback filter). The second optimal filtering set value may be applied to the second filtering circuit and may indicate feedforward filter coefficients (e.g., a second subset of values of the optimal filter set value set corresponding to the feedforward filter).

The noise processing circuit 500 may change a set value of the first filtering circuit based on the first optimal filtering set value included in the selected optimal filter set value set. For example, the noise processing circuit 500 may output a first control signal for changing, based on the first optimal filtering set value, the set value of the first filtering circuit. The set value of the first filtering circuit may be changed based on the first control signal. For example, the set value of the first filtering circuit may be changed as the selected first optimal filtering set value, based on the first control signal.

The noise processing circuit 500 may change a set value of the second filtering circuit based on the second optimal filtering set value included in the selected optimal filter set value set. For example, the noise processing circuit 500 may output a second control signal for changing, based on the second optimal filtering set value, the set value of the second filtering circuit. The set value of the second filtering circuit may be changed based on the second control signal. For example, the set value of the second filtering circuit may be changed as the selected second optimal filtering set value, based on the second control signal.

According to an embodiment, the electronic device 10 may include a processor. The processor may control general operations of the electronic device 10. According to an embodiment, the noise processing circuit 500 may be included in the processor. The processor may include one or more of a central processing unit (CPU), an application processor (AP), or a communication processor (CP). The processor may control at least another component of the electronic device 10 and/or perform an operation or data processing with respect to communication.

The memory 600 may be a storage for storing data and may store, for example, the reference secondary paths. Also, the memory 600 may store the optimal filter set value sets corresponding to the reference secondary paths, respectively. The memory 600 may include at least one of a volatile memory and a nonvolatile memory. The nonvolatile memory may include read-only memory (ROM), programmable read-only memory (PROM), electrically programmable read-only memory (EPROM), electrically erasable and programmable read-only memory (EEPROM), flash memory, phase-change random-access memory (PRAM), magnetic random-access memory (MRAM), resistive random-access memory (RRAM), etc. The volatile memory may include dynamic random-access memory (DRAM), static random-access memory (SRAM), synchronous dynamic random-access memory (SDRAM), PRAM, MRAM, RRAM, ferroelectric random-access memory (FeRAM), etc. Also, according to an embodiment, the memory 600 may include at least one of a hard disk drive (HDD), a solid state drive (SSD), compact flash (CF), secure digital (SD), micro-SD, mini-SD, extreme digital (xD), or a memory stick. According to an embodiment, the memory 600 may semi-permanently or temporarily store algorithms, programs, and a plurality of instructions executed by the noise processing circuit 500.

The noise processing circuit 500 may adjust the filtering circuit 300 by using the optimal filter set value set corresponding to the reference secondary path the most similar to the object secondary path, and thus, the filtering circuit 300 may be adjusted according to the secondary path according to each user and the noise canceling performance may be improved. Also, the noise processing circuit 500 may adjust the set value of the filtering circuit 300 by selecting an optimal filter set value set from among a plurality of pre-set optimal filter set value sets, and thus, the amount of calculation and the battery consumption for adjusting the set value of the filtering circuit 300 and the battery consumption may be reduced. The optimal filter set value sets may each be an optimized filter set value set, and in some embodiments, the memory 600 may store a predetermined and limited number (e.g., between 5-7) of optimized filter set value sets from which to choose from when setting the filter coefficients for the filtering circuit 300. The optimization may be based on, for example, a set of sample signals generated during testing (described further below), wherein a pre-set number of filter set value sets are chosen to best match (e.g., optimally match) clusters of sample signals.

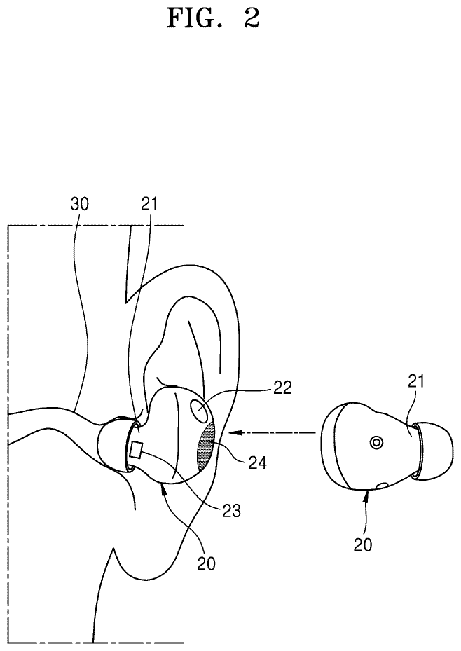

FIG. 2 is a view for describing an ear-wearable device 20 according to an embodiment. The ear-wearable device 20 of FIG. 2 may correspond to the electronic device 10 of FIG. 1, and the same aspects are not repeatedly described.

The ear-wearable device 20 may be or include an electronic device for outputting a sound signal. The ear-wearable device 20 may be mounted on cars of a user. The ear-wearable device 20 may include a protrusion portion 21, a first microphone 22, and a second microphone 23. According to an embodiment, the ear-wearable device 20 may further include a touch sensing sensor 24. However, the disclosure is not necessarily limited thereto. According to necessity or desired design, the ear-wearable device 20 may further include other components and may not include at least one of the components illustrated in FIG. 2.

The protrusion portion 21 may have a protruding structure for outputting an audio signal through a speaker. When the ear-wearable device 20 is mounted on the cars of the user, the protruding portion 21 may be inserted into the external acoustic meatus 30 or may be positioned to be adjacent to the external acoustic meatus 30. The external acoustic meatus 30 may be a path through which a sound signal is propagated when the ear-wearable device 20 is mounted on the cars of the user.

The ear-wearable device 20 may include the first microphone 22 (for example, the first microphone 100 of FIG. 1) and the second microphone 23 (for example, the second microphone 200 of FIG. 1). The first microphone 22 may be a feedforward microphone. The first microphone 22 may be referred to as a reference microphone. According to an embodiment, the first microphone 22 may be used for a noise removal technique for removing an external noise signal. To offset the external noise signal received from the first microphone 22, a noise processing circuit (for example, the noise processing circuit 500 of FIG. 1) may adjust a filtering circuit (for example, the filtering circuit 300 of FIG. 1) by selecting an optimal filter set value set. The filtering circuit 300 may include the second filtering circuit, and the second filtering circuit may generate the second offset signal for offsetting the noise signal. For example, the second offset signal may be generated based on phase information of the noise signal. For example, a phase of the second offset signal may be the opposite to a phase of the noise signal.

The second microphone 23 may be a feedback microphone. The second microphone 23 may be referred to as an error microphone. According to an embodiment, the second microphone 23 may be used for a noise removal technique for removing or reducing the error signal. To remove or reduce the error signal received from the second microphone 23, the noise processing circuit (for example, the noise processing circuit 500 of FIG. 1) may adjust the filtering circuit (for example, the filtering circuit 300 of FIG. 1) by selecting an optimal filter set value set. The filtering circuit 300 may include the first filtering circuit, and the first filtering circuit may generate the first offset signal for offsetting the error signal. For example, the first offset signal may be generated based on the phase information of the error signal. For example, a phase of the first offset signal may be opposite to a phase of the error signal.

The first microphone 22 and the second microphone 23 may be arranged in the ear-wearable device 20 to be apart from each other. When the ear-wearable device 20 is mounted on the cars of the user, the first microphone 22 may be arranged to be relatively farther from the ear-wearable device 20 with respect to the external acoustic meatus 30 than the second microphone 23 is. The first microphone 22 may be arranged at a relatively increased distance from the protrusion portion 21. When the ear-wearable device 20 is mounted on the cars of the user, the second microphone 23 may be arranged to be relatively closer to the ear-wearable device 20 with respect to the external acoustic meatus 30 than the first microphone 22 is. The second microphone 23 may be arranged at a relatively decreased distance from the protrusion portion 21.

According to an embodiment, the ear-wearable device 20 may further include the touch sensing sensor 24. The touch sensing sensor 24 may sense a touch input of the user. For example, a processor included in the ear-wearable device 20 (for example, the electronic device 10 of FIG. 1) may identify the user's touch input through the touch sensing sensor 24. The processor may control an operation of the ear-wearable device 20 based on the user's touch input. For example, when the touch input is received by the touch sensing sensor 24 once, the processor may pause an audio signal which is being reproduced. For example, when the touch input is received by the touch sensing sensor 24 twice, the processor may play the temporarily paused audio signal again. Other types of user input buttons, switches, or sensors may be used as well, other than a touch sensing sensor.

Although not shown in FIG. 2, the ear-wearable device 20 may further include a charging terminal. The charging terminal may include a terminal configured to provide a power supply to the ear-wearable device 20. The charging terminal may include a conductive pad corresponding to a power supply device. For example, the charging terminal may be connected to a power supply device, and while the charging terminal is connected to the power supply device, the charging terminal and the power supply device may be arranged to be physically in contact with each other. For example, when the charging terminal of the ear-wearable device 20 is connected to the power supply device, the conductive pad of the charging terminal and a conductive pin of the power supply device may be electrically connected to each other.

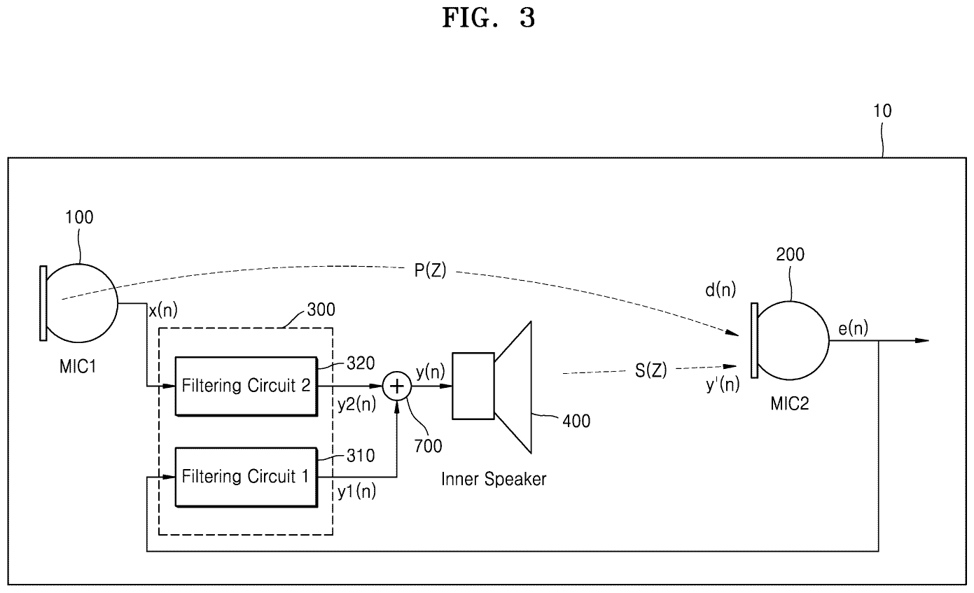

FIG. 3 is a view for describing the filtering circuit 300 according to an embodiment. The electronic device 10, the first microphone 100, the second microphone 200, the filtering circuit 300, and the inner speaker 400 of FIG. 3 may correspond to the electronic device 10, the first microphone 100, the second microphone 200, the filtering circuit 300, and the inner speaker 400 of FIG. 1, respectively. The same aspects as described with reference to FIG. 1 are not repeatedly described.

The first microphone 100 may receive a noise signal x(n). For example, the first microphone 100 may receive the noise signal x(n) from the outside of the electronic device 10. The noise signal x(n) may be transmitted to the second filtering circuit 320.

The second microphone 200 may receive an input signal and output an error signal c(n). The error signal e(n) may be the difference between a noise signal d(n) transmitted through a primary path P(Z) and an offset signal y′(n) transmitted through a secondary path S(Z). The error signal c(n) may be transmitted to the first filtering circuit 310.

The primary path P(Z) may be formed from the first microphone 100 to the second microphone 200. The primary path P(Z) may refer to a transmission function from the first microphone 100 to the second microphone 200. The secondary path S(Z) may be formed from the inner speaker 400 to the second microphone 200. The secondary path S(Z) may refer to a transmission function from the inner speaker 400 to the second microphone 200.

Referring to FIG. 3, the filtering circuit 300 may include a first filtering circuit 310 and a second filtering circuit 320. The first filtering circuit 310 may generate a first offset signal y1(n) for offsetting the error signal e(n). The first filtering circuit 310 may receive the error signal e(n) and generate the first offset signal y1(n). The first filtering circuit 310 may generate the first offset signal y1(n) and may at least partially remove the error signal c(n) (e.g., may reduce or remove the error signal c(n)).

The second filtering circuit 320 may generate a second offset signal y2(n) for offsetting the noise signal x(n). The second filtering circuit 320 may receive the noise signal x(n) and generate the second offset signal y2(n). The second filtering circuit 320 may generate the second offset signal y2(n) and may at least partially remove the noise signal x(n) (e.g., may reduce or remove the noise signal x(n)).

An adder 700 may add the first offset signal y1(n) and the second offset signal y2(n). The first offset signal y1(n) and the second offset signal y2(n) may be added to generate an offset signal y(n). The offset signal y(n), which is an electrical signal, may reduce the noise signal x(n) and the error signal c(n). The offset signal y(n) may be transmitted to the inner speaker 400.

The inner speaker 400 may output the offset signal y′(n), which is an acoustic signal based on the electrical offset signal y(n). The offset signal y′(n) transmitted through the secondary path S(Z) may offset the noise signal d(n) transmitted through the primary path P(Z). The offset signal y′(n) may correspond to the offset signal y(n) input to the inner speaker 400 and may be transmitted through the secondary path S(Z), and the noise signal d(n) may correspond to the noise signal x(n) transmitted through the primary path P(Z).

The secondary path S(Z) may vary according to a user. Each user may have a different ear shape and an ear length, which may affect the secondary path S(Z). When the same, un-adjustable, first filtering circuit 310 and the same, un-adjustable, second filtering circuit 320 are used for every user, degraded or poor noise removal performance may be provided for some users. Thus, it is desirable to adjust the first filtering circuit 310 and the second filtering circuit 320 according to each user.

When the first filtering circuit 310 and the second filtering circuit 320 are adjusted according to each user using the electronic device 10, filter coefficients of the first filtering circuit 310 and the second filtering circuit 320 may be adaptively calculated. Thus, the amount of calculation and the battery consumption may be increased. However, the electronic device 10 according to various embodiments may adjust the first filtering circuit 310 and the second filtering circuit 320 according to each user using the electronic device 10, while reducing the amount of calculation and the battery consumption.

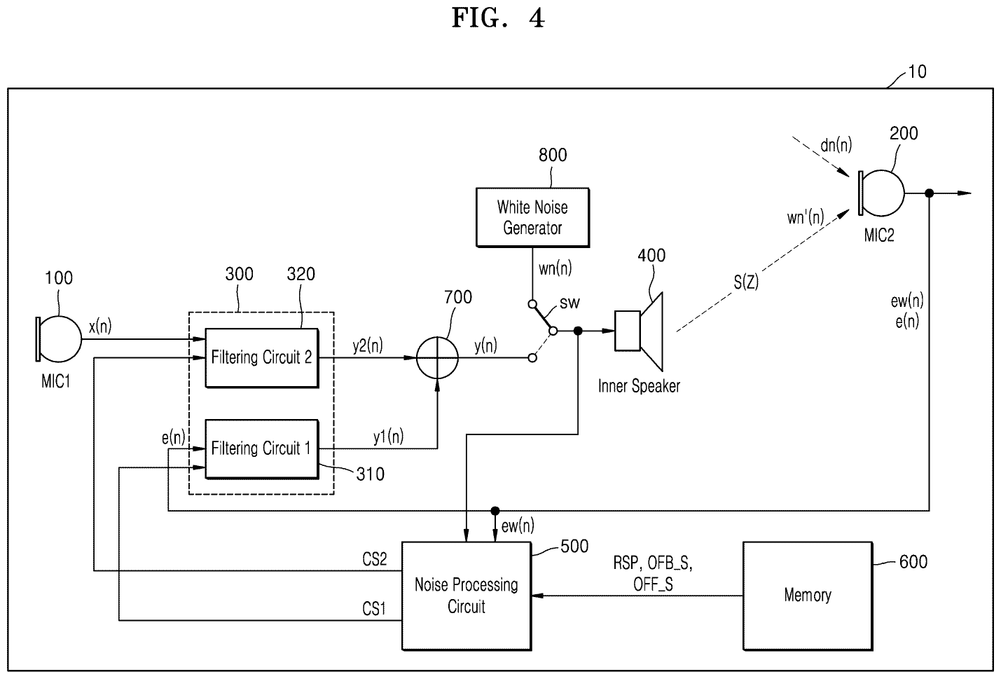

FIG. 4 is a view for describing an operation of the noise processing circuit 500 according to an embodiment. The same aspects as described above are omitted.

Referring to FIG. 4, the noise processing circuit 500 may adjust a set value of the filtering circuit 300. The noise processing circuit 500 may adjust a set value of the first filtering circuit 310 and a set value of the second filtering circuit 320. The filtering circuit 300 may be designed or adjusted based on the set values. Adjusting the set value of the filtering circuit 300 may include changing one or more filter coefficients of the filtering circuit 300. The noise processing circuit 500 may output a first control signal CS1 for adjusting the set value of the first filtering circuit 310 and a second control signal CS2 for adjusting the set value of the second filtering circuit 320.

When the noise processing circuit 500 finishes adjusting the filtering circuit 300, the offset signal y(n) for offsetting the noise signal x(n) and the error signal e(n) may be generated. For example, when a user wears the electronic device 10, the noise processing circuit 500 may adjust the set value of the filtering circuit 300, and when the set value of the filtering circuit 300 is adjusted, the offset signal y(n) may be generated. However, the disclosure is not necessarily limited thereto, and the noise processing circuit 500 may adjust the set value of the filtering circuit 300 at various time points.

The noise processing circuit 500 may estimate the secondary path S(Z) and may adjust the set value of the filtering circuit 300 based on an object secondary path. The secondary path S(Z) estimated by the noise processing circuit 500 in the electronic device 10 may be referred to as the object secondary path. According to an embodiment, the noise processing circuit 500 may estimate the secondary path S(Z) by using an inner sound signal of the electronic device 10. The inner sound signal may denote an inner sound source generated in the electronic device 10 or stored in the electronic device 10. For example, the inner sound signal may include a white noise signal wn(n). However, the inner sound signal is not necessarily limited thereto. The noise processing circuit 500, as well as the filtering circuit 1, filtering circuit 2, and white noise generator 800, and other processing components described herein, may be implemented on a processor or other integrated circuit chip, and may include hardware components and may also be implemented with additional software or program code. The noise processing circuit 500, as well as the filtering circuit 1, filtering circuit 2, and white noise generator 800 may be separate components, which communicate via different communication methods, or may be a combined component (e.g., may be included together in a single processor or integrated circuit chip).

According to an embodiment, the electronic device 10 may further include a white noise generator 800, and the noise processing circuit 500 may estimate the secondary path S(Z) based on the white noise signal wn(n) generated by the white noise generator 800. For example, in order for the noise processing circuit 500 to estimate the secondary path S(Z), a switching device SW may connect the white noise generator 800 to the inner speaker 400. When the noise processing circuit 500 is not being used to estimate the secondary path S(Z), the switching device SW may connect the adder 700 to the inner speaker 400.

According to an embodiment, the noise processing circuit 500 may estimate the secondary path S(Z) based on the inner sound signal and an error signal with respect to the inner sound signal received from the second microphone 200. For example, the noise processing circuit 500 may estimate the secondary path S(Z) based on the white noise signal wn(n) and an error signal ew(n) with respect to the white noise signal wn(n).

The noise processing circuit 500 may receive the white noise signal wn(n) generated from the white noise generator 800. The noise processing circuit 500 may receive the error signal ew(n) with respect to the white noise signal wn(n). The error signal ew(n) may be a signal that has a difference from the white noise signal wn(n), which difference may be caused by the secondary path S(Z). For example, the acoustic signal wn′(n) may be converted to an electrical signal ew(n), and the signal ew(n) may have a difference from the white noise signal wn(n) generated from the white noise generator 800, based on changes due to the secondary path S(Z). In this manner, the noise processing circuit 500 may estimate a transmission function of the object secondary path.

The noise processing circuit 500 may select, based on the object secondary path, one of optimal filter set value sets stored in the memory 600. A plurality of reference secondary paths RSP, first optimal filtering set values respectively corresponding to the reference secondary paths RSP, and second optimal filtering set values respectively corresponding to the reference secondary paths RSP may be stored in the memory 600. According to an embodiment, the noise processing circuit 500 may compare the object secondary path with the reference secondary paths RSP. The noise processing circuit 500 may compare the object secondary path with each of the plurality of reference secondary paths RSP. The noise processing circuit 500 may read and compare the reference secondary paths RSP stored in the memory 600 with the object secondary path.

The noise processing circuit 500 may select one of the optimal filter set value sets, based on a result of comparing the object secondary path with each of the reference secondary paths RSP. For example, the noise processing circuit 500 may select a reference secondary path RSP having the least difference from the object secondary path and an optimal filter set value set corresponding to the corresponding reference secondary path RSP. This may be accomplished to adjust the offset signal y(n) without further considering a primary path transmission function (e.g., without further analyzing or considering the primary path between the first microphone 100 and the second microphone 200). The selected optimal filter set value set may include a first optimal filtering set value OFB_S and a second optimal filtering set value OFF_S. The noise processing circuit 500 may change a set value of the first filtering circuit 310 based on the first optimal filtering set value OFB_S. For example, the noise processing circuit 500 may output a first control signal CS1 for changing the set value of the first filtering circuit 310. The noise processing circuit 500 may change a set value of the second filtering circuit 320 based on the second optimal filtering set value OFF_S. For example, the noise processing circuit 500 may output a second control signal CS2 for changing the set value of the second filtering circuit 320.

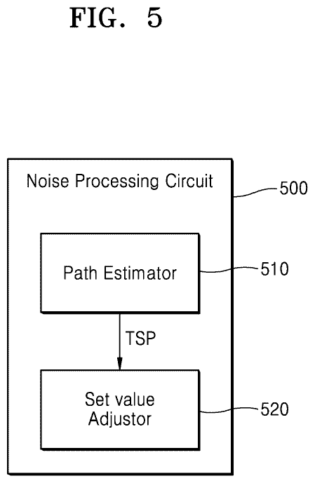

FIG. 5 is a block diagram of the noise processing circuit 500 according to an embodiment. The same aspects as described above are omitted.

Referring to FIG. 5, the noise processing circuit 500 may include a path estimator 510 and a set value adjustor 520. The path estimator 510 may estimate an object secondary path TSP. According to an embodiment, the path estimator 510 may estimate the secondary path by using an inner sound signal of an electronic device (for example, the electronic device 10 of FIG. 4). The path estimator 510 may estimate the secondary path based on the inner sound signal and an error signal with respect to the inner sound signal received from a second microphone (for example, the second microphone 200 of FIG. 4). The path estimator 510 may estimate a transmission function of the object secondary path TSP. The path estimator 510 may transmit the object secondary path TSP to the set value adjustor 520. The path estimator 510 may transmit the transmission function of the object secondary path TSP to the set value adjustor 520.

The set value adjustor 520 may compare the object secondary path TSP with reference secondary paths. Based on the result of comparing the object secondary path TSP with the reference secondary paths, the set value adjustor 520 may select one of optimal filter set value sets stored in a memory (for example, the memory 600 of FIG. 4). The set value adjustor 520 may adjust the set value of the filtering circuit based on the selected optimal filter set value set. Hereinafter, a method of selecting the optimal filter set value set is described in detail with reference to FIG. 6.

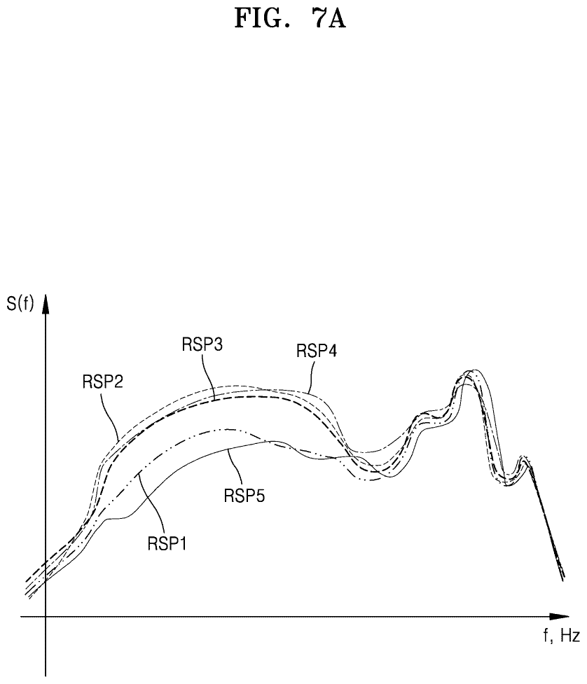

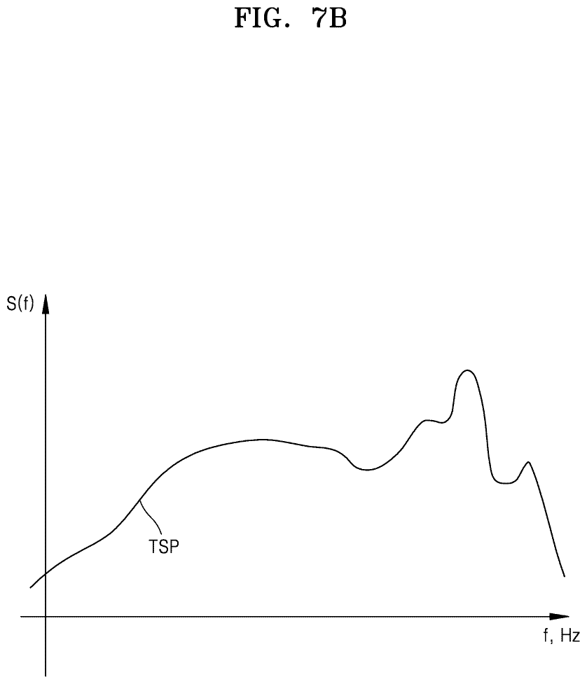

FIG. 6 is a view for describing a method of selecting an optimal filter set value set, according to an embodiment. FIG. 7A is a graph showing frequency response amplitudes of a plurality of reference secondary paths. FIG. 7B is a graph showing a frequency response amplitude of an object secondary path. FIG. 6 illustrates an operation of the noise processing circuit 500. In detail, FIG. 6 may indicate an operation of the set value adjustor 520 of FIG. 5.

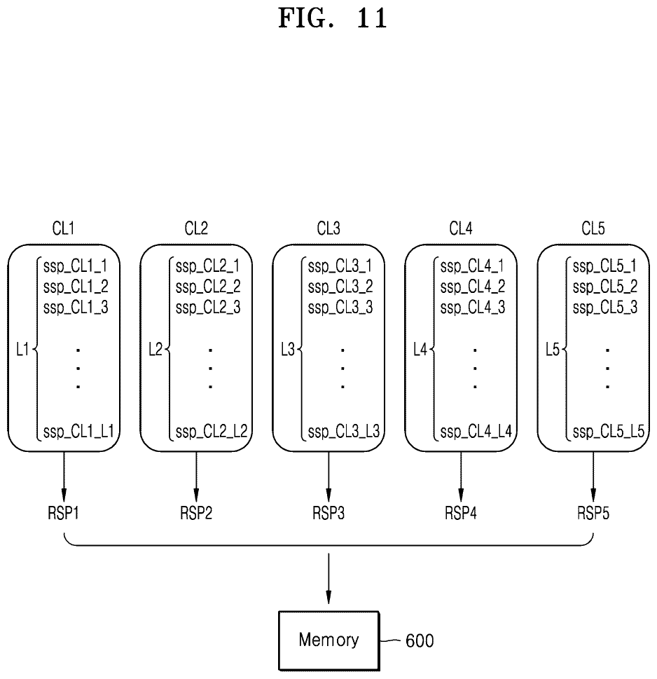

The memory 600 may store the plurality of reference secondary paths RSP and optimal filter set value sets OFS corresponding to the plurality of reference secondary paths, respectively. The plurality of reference secondary paths RSP may correspond to clusters, respectively. The reference secondary path RSP may be pre-stored in the memory 600 and may denote a secondary path representing the cluster. The cluster may include a plurality of sample secondary paths that are clustered, and the sample secondary paths may denote secondary paths obtained through a test. According to an embodiment, the reference secondary path may be an average value of the sample secondary paths included in the cluster. The cluster and the sample secondary path will be described in detail with reference to FIG. 11.

The reference secondary paths RSP may correspond to first to fifth clusters CL1 to CL5, respectively. The optimal filter set value sets OFS may correspond to the first to fifth clusters CL1 to CL5, respectively. For example, five reference secondary paths RSP and five optimal filter set value sets OFS may be stored in the memory 600. The memory 600 may store a first reference secondary path RSP1 and a first optimal filter set value set OFS1 corresponding to the first cluster CL1, a second reference secondary path RSP2 and a second optimal filter set value set OFS2 corresponding to the second cluster CL2, a third reference secondary path RSP3 and a third optimal filter set value set OFS3 corresponding to the third cluster CL3, a fourth reference secondary path RSP4 and a fourth optimal filter set value set OFS4 corresponding to the fourth cluster CL4, and a fifth reference secondary path RSP5 and a fifth optimal filter set value set OFS5 corresponding to the fifth cluster CL5. However, the disclosure is not necessarily limited thereto. The number of clusters may vary and various numbers of reference secondary paths and optimal filter set value sets may be stored in the memory 600.

The optimal filter set value set OFS may include a first optimal filtering set value OFB and a second optimal filtering set value OFF. For example, the first optimal filter set value set OFS1 may include a first optimal filtering set value OFB1 and a second optimal filtering set value OFF1. The second optimal filter set value set OFS2 may include a first optimal filtering set value OFB2 and a second optimal filtering set value OFF2. The third optimal filter set value set OFS3 may include a first optimal filtering set value OFB3 and a second optimal filtering set value OFF3. The fourth optimal filter set value set OFS4 may include a first optimal filtering set value OFB4 and a second optimal filtering set value OFF4. The fifth optimal filter set value set OFS5 may include a first optimal filtering set value OFB5 and a second optimal filtering set value OFF5.

The first optimal filtering set value OFB may be applied to the first filtering circuit and may indicate feedback filter coefficients. The second optimal filtering set value OFF may be applied to the second filtering circuit and may indicate feedforward filter coefficients. The noise processing circuit 500 may change the set value of the first filtering circuit based on the first optimal filtering set value OFB included in the selected optimal filter set value set OFS. The noise processing circuit 500 may change the set value of the second filtering circuit based on the second optimal filtering set value OFB included in the selected optimal filter set value set OFS.

The noise processing circuit 500 may compare the object secondary path TSP with each of the plurality of reference secondary paths RSP. The noise processing circuit 500 may read and compare the reference secondary paths RSP stored in the memory 600 with the object secondary path TSP. The noise processing circuit 500 may obtain the difference between the object secondary path TSP and each of the plurality of reference secondary paths RSP.

For example, the noise processing circuit 500 may convert the object secondary path TSP into a frequency domain and calculate a frequency response amplitude of the object secondary path TSP, and the noise processing circuit 500 may calculate a deviation between the frequency response amplitude of the object secondary path TSP and a frequency response amplitude of the reference secondary path RSP. For example, the noise processing circuit 500 may filter the object secondary path TSP by using the Wiener Filter and may perform the Fourier transform on the filtered object secondary path TSP to obtain the frequency response amplitude.

FIG. 7A shows the frequency response amplitudes of the reference secondary paths RSP. The horizontal axis of the graph of FIG. 7A indicates the frequency and the frequency unit may be Hz. The vertical axis may indicate the frequency response amplitude. Referring to FIGS. 6 and 7A together, the frequency response amplitude of each of the plurality of reference secondary paths RSP may be different from each other. According to an embodiment, each of the reference secondary paths RSP may be stored in the memory 600 in the form of the frequency response amplitude. However, the disclosure is not necessarily limited to.

FIG. 7B indicates the frequency response amplitude of the object secondary path TSP. The horizontal axis of the graph of FIG. 7B indicates the frequency and the frequency unit may be Hz. The vertical axis may indicate the frequency response amplitude. Referring to FIGS. 6, 7A, and 7B, the noise processing circuit 500 may calculate the deviation between the frequency response amplitude of the object secondary path TSP and the frequency response amplitude of each of the plurality of reference secondary paths RSP.

For example, the noise processing circuit 500 may obtain a first deviation DSP1 between the frequency response amplitude of the object secondary path TSP and the frequency response amplitude of the first reference secondary path RSP1. For example, the noise processing circuit 500 may obtain a second deviation DSP2 between the frequency response amplitude of the object secondary path TSP and the frequency response amplitude of the second reference secondary path RSP2. For example, the noise processing circuit 500 may obtain a third deviation DSP3 between the frequency response amplitude of the object secondary path TSP and the frequency response amplitude of the third reference secondary path RSP3. For example, the noise processing circuit 500 may obtain a fourth deviation DSP4 between the frequency response amplitude of the object secondary path TSP and the frequency response amplitude of the fourth reference secondary path RSP4. For example, the noise processing circuit 500 may obtain a fifth deviation DSP5 between the frequency response amplitude of the object secondary path TSP and the frequency response amplitude of the fifth reference secondary path RSP5.

According to an embodiment, the noise processing circuit 500 may calculate, based on a frequency domain, the deviation between each of the reference secondary paths RSP and the object secondary path TSP. The noise processing circuit 500 may calculate, based on the frequency domain, the deviation of the frequency response amplitude between each of the reference secondary paths RSP and the object secondary path TSP. The frequency domain may denote a domain between a first frequency and a second frequency. The noise processing circuit 500 may calculate, based on at least some frequencies of the frequency domain, the deviation of the frequency response amplitude between each of the reference secondary paths RSP and the object secondary path TSP.

The noise processing circuit 500 may select one of the optimal filter set value sets OFS, based on a comparison result generated by comparing the object secondary path TSP with each of the reference secondary paths RSP. According to an embodiment, the noise processing circuit 500 may select, from among the optimal filter set value sets OFS, an optimal filter set value set corresponding to a reference secondary path having the least deviation from the object secondary path TSP. For example, assuming that the fifth deviation DSP5 is the least from among the first deviation DSP1, the second deviation DSP2, the third deviation DSP3, the fourth deviation DSP4, and the fifth deviation DSP5, the noise processing circuit 500 may select the fifth optimal filter set value set OFS5 corresponding to the fifth reference secondary path RSP5. The noise processing circuit 500 may change the set value of the filtering circuit (for example, the filtering circuit 300 of FIG. 4) based on the fifth optimal filter set value set OFS5. The noise processing circuit 500 may change the set value of the first filtering circuit (for example, the set value of the first filtering circuit 310 of FIG. 4) based on the first optimal filtering set value OFB5 and may change the set value of the second filtering circuit (for example, the second filtering circuit 320 of FIG. 4) based on the second optimal filtering set value OFF5.

The noise processing circuit 500 may search for the reference secondary path RSP which is the most similar to the object secondary path TSP and may select the optimal filter set value set OFS corresponding to the most similar reference secondary path RSP. The noise processing circuit 500 may adjust the filtering circuit by using the optimal filter set value set OFS corresponding to the reference secondary path RSP the most similar to the object secondary path TSP, and thus, the filtering circuit 300 may be adjusted based on the secondary path according to each user and the noise canceling performance may be improved. Also, by selecting one of the optimal filter set value sets OFS stored in the memory 600, the noise processing circuit 500 may reduce the amount of calculation required for adjusting the set value of the filtering circuit, while reducing the battery consumption.

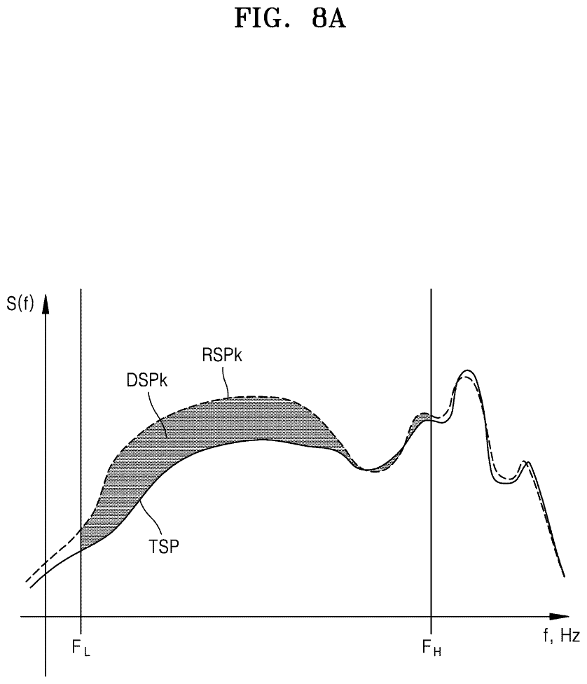

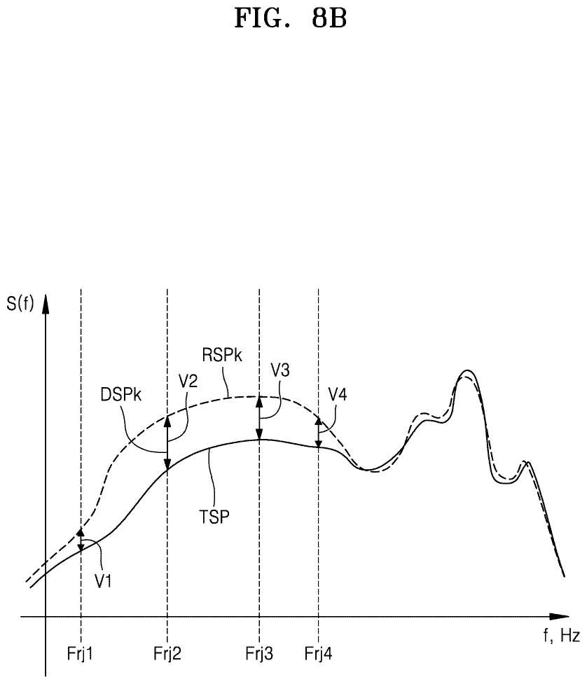

FIG. 8A is a view for describing a method of obtaining a deviation, according to an embodiment. The same aspects as described with reference to FIG. 6 are omitted. Hereinafter, FIG. 6 is also referred to.

Referring to FIG. 8A, the horizontal axis of the graph of FIG. 8A indicates the frequency and the frequency unit may be Hz. The vertical axis may indicate the frequency response amplitude. FIG. 8A illustrates the frequency response amplitude of the object secondary path TSP and the frequency response amplitude of a k^{th} reference secondary path RSPk. The k^{th} reference secondary path RSPk may denote one of the reference secondary paths RSP.

According to an embodiment, the noise processing circuit 500 may calculate, based on a frequency domain, a deviation between each of the reference secondary paths RSP and the object secondary path TSP. The noise processing circuit 500 may calculate, based on the frequency domain, the deviation of the frequency response amplitude between each of the reference secondary paths RSP and the object secondary path TSP. The frequency domain may denote a domain between a first frequency FL and a second frequency FH. The first frequency FL may denote the minimum frequency in the frequency domain, and the second frequency FH may denote the maximum frequency in the frequency domain.

A deviation DSPk of the k^{th} reference secondary path may be represented by Equation 1 below.

$$DSPk = {\sum }_{j = F L}^{FH} abs [ TSP ( Fj ) - RSPk ( ( Fj ) ] \qquad [ Equation 1 ]$$

Here, FL may indicate the first frequency, FH may indicate the second frequency, TSP may indicate the frequency response amplitude of the object secondary path, RSPk may indicate the frequency response amplitude of the k^{th} reference secondary path, and Fj may indicate the frequencies j.

The deviation DSPk may be the sum of absolute values of the difference between the frequency response amplitude of the object secondary path TSP and the frequency response amplitude of the reference secondary path RSP with respect to the frequencies Fj included in the frequency domain. For example, the deviation DSPk may be calculated by obtaining, for every Hz between the first frequency FL and the second frequency FH, the absolute value of the difference between the frequency response amplitude of the object secondary path TSP and the frequency response amplitude of the reference secondary path RSP and summing the absolute values. However, the disclosure is not necessarily limited thereto. The deviation DSPk may be the sum of absolute values of the difference between the frequency response amplitude of the object secondary path TSP and the frequency response amplitude of the reference secondary path RSP based on various frequency units. For example, the deviation DSPk may be calculated by obtaining, for every 2 Hz between the first frequency FL and the second frequency FH, the absolute value of the difference between the frequency response amplitude of the object secondary path TSP and the frequency response amplitude of the reference secondary path RSP and summing the absolute values.

FIG. 8B is a view for describing a method of obtaining a deviation, according to an embodiment. The same aspects as described above are omitted. Hereinafter, FIG. 6 is also referred to.

Referring to FIG. 8B, the horizontal axis of the graph of FIG. 8B indicates the frequency and the frequency unit may be Hz. The vertical axis may indicate the frequency response amplitude. FIG. 8B illustrates the frequency response amplitude of the object secondary path TSP and the frequency response amplitude of the k^{th} reference secondary path RSPk. The k^{th} reference secondary path RSPk may indicate one of the reference secondary paths RSP.

According to an embodiment, the noise processing circuit 500 may calculate, based on a set of representative frequencies Frj, the deviation of the frequency response amplitude between each of the reference secondary paths RSP and the object secondary path TSP. The noise processing circuit 500 may calculate, based on each representative frequency Frj included in the frequency domain, the deviation of the frequency response amplitude between each of the reference secondary paths RSP and the object secondary path TSP. The set of representative frequencies Frj may include an arbitrary number of frequencies included in the frequency domain. The set of representative frequencies Frj may include various numbers of frequencies, for example, two frequencies, four frequencies, etc.

For example, the set of representative frequencies Frj may be set based on user information. For example, the representative frequencies Frj may be set based on a user's age, etc. The representative frequencies Frj may be differently set between when the user is a child and when the user is an adult. FIG. 8B illustrates that there are four representative frequencies Frj. It is illustrated that there are four representative frequencies Frj, for convenience of explanation. However, the disclosure is not necessarily limited thereto, and a deviation DSPk of the k^{th} reference secondary path may be obtained based on various numbers of representative frequencies Frj.

The deviation DSPk of the k^{th} reference secondary path may be the sum of absolute values of the difference between the frequency response amplitude of the object secondary path TSP and the frequency response amplitude of the k^{th} reference secondary path RSPk with respect to the representative frequencies Frj. For example, with respect to a first representative frequency Frj1, the absolute value of the difference between the frequency response amplitude of the object secondary path TSP and the frequency response amplitude of the k^{th} reference secondary path RSPk may be a first value V1. With respect to a second representative frequency Frj2, the absolute value of the difference between the frequency response amplitude of the object secondary path TSP and the frequency response amplitude of the k^{th} reference secondary path RSPk may be a second value V2. With respect to a third representative frequency Frj3, the absolute value of the difference between the frequency response amplitude of the object secondary path TSP and the frequency response amplitude of the k^{th} reference secondary path RSPk may be a third value V3. With respect to a fourth representative frequency Frj4, the absolute value of the difference between the frequency response amplitude of the object secondary path TSP and the frequency response amplitude of the k^{th} reference secondary path RSPk may be a fourth value V4. The deviation DSPk of the k^{th} reference secondary path may be the sum of the first value V1, the second value V2, the third value V3, and the fourth value V4.

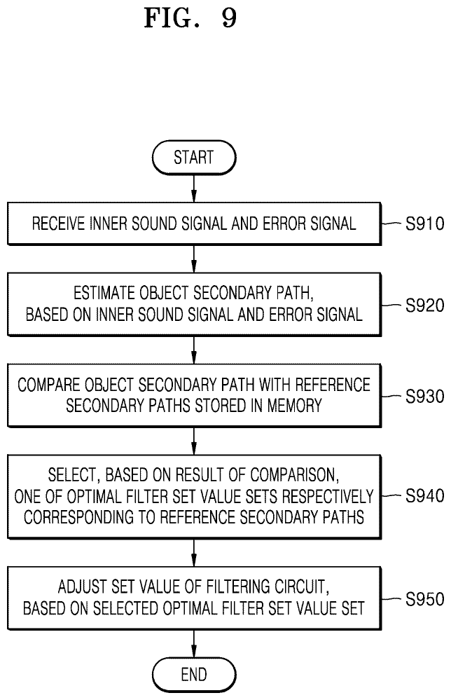

FIG. 9 is a flowchart of an operating method of a noise processing circuit, according to an embodiment. In detail, FIG. 9 shows the operating method of the noise processing circuit (for example, the noise processing circuit 500 of FIG. 4) according to an embodiment.

In operation S910, the noise processing circuit may receive an inner sound signal and an error signal. The inner sound signal may denote an inner sound source generated in an electronic device (for example, the electronic device 10 of FIG. 4) or stored in the electronic device. For example, the inner sound signal may include a white noise signal. However, the disclosure is not necessarily limited thereto. An error signal may denote the difference between a noise signal transmitted through a primary path and an offset signal transmitted through a secondary path.

In operation S920, the noise processing circuit may estimate an object secondary path based on the inner sound signal and the error signal. For example, the noise processing circuit may estimate a secondary path based on the white noise signal and the error signal with respect to the white noise signal. The secondary path may denote a transmission function between an inner speaker (for example, the inner speaker 400 of FIG. 4) and a second microphone (for example, the second microphone 200 of FIG. 3) and may also be referred to as a transmission path.

Estimating the secondary path may include estimating the transmission function of the secondary path. Also, estimating the secondary path may include calculating an amplitude of a frequency response of the secondary path. The secondary path estimated by the noise processing circuit may also be referred to as the object secondary path.

In operation S930, the noise processing circuit may compare the object secondary path with reference secondary paths. The reference secondary paths may be stored in a memory (for example, the memory 600 of FIG. 4). The reference secondary paths may be pre-stored or pre-set in the memory. The noise processing circuit may change a set value of the filtering circuit 300. The reference secondary paths may be pre-stored in the memory.

The noise processing circuit may compare the object secondary path with each of the plurality of reference secondary paths. The noise processing circuit 500 may read the reference secondary paths stored in the memory and compare each of the reference secondary paths with the object secondary path. For example, when a first reference secondary path and a second reference secondary path are stored in the memory, the noise processing circuit may compare the object secondary path with the first reference secondary path and may compare the object secondary path with the second reference secondary path.

For example, the noise processing circuit may convert the object secondary path into a frequency domain, may calculate a frequency response amplitude of the object secondary path, and may calculate a deviation between the frequency response amplitude of the object secondary path and a frequency response amplitude of each of the reference secondary paths.

In operation S940, based on a comparison result of comparing the object secondary path with each of the reference secondary paths, the noise processing circuit may select one of optimal filter set value sets. The memory may store the plurality of reference secondary paths and plurality of optimal filter set value sets corresponding to the plurality of reference secondary paths, respectively. The optimal filter set value sets may correspond to the plurality of reference secondary paths, respectively, and may be filter set values for optimizing the corresponding reference secondary paths, respectively.

According to an embodiment, the noise processing circuit may select, from among the optimal filter set value sets, an optimal filter set value set corresponding to a reference secondary path having the least deviation from the object secondary path. As one example, it is assumed that of a first deviation which is the difference between a first reference secondary path and the object secondary path and a second deviation which is the difference between a second reference secondary path and the object secondary path, the second deviation is less than the first deviation. Because the second deviation is less than the first deviation, the noise processing circuit may select the optimal filter set value set corresponding to the second reference secondary path.

According to an embodiment, the optimal filter set value set may include a first optimal filtering set value and a second optimal filtering set value. The first optimal filtering set value may be applied to a first filtering circuit and may indicate feedback filter coefficients. The second optimal filtering set value may be applied to a second filtering circuit and may indicate feedforward filter coefficients.

In operation S950, the noise processing circuit may adjust the set value of the filtering circuit based on the selected optimal filter set value set. For example, the noise processing circuit may change the set value of the filtering circuit by using the selected optimal filter set value set.

The noise processing circuit may change a set value of the first filtering circuit based on the first optimal filtering set value included in the selected optimal filter set value set. For example, the noise processing circuit may change the set value of the first filtering circuit as the first optimal filtering set value included in the selected optimal filter set value set. For example, the noise processing circuit may change a set value of the second filtering circuit based on the second optimal filtering set value included in the selected optimal filter set value set. For example, the noise processing circuit may change the set value of the second filtering circuit as the second optimal filtering set value included in the selected optimal filter set value set.

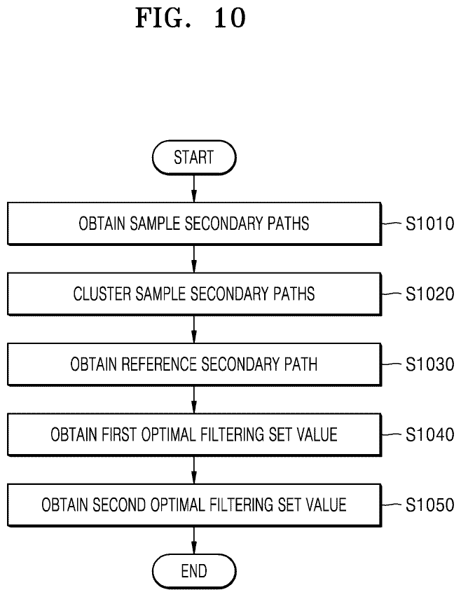

FIG. 10 is a flowchart of a method of obtaining a reference secondary path and an optimal filter set value set, according to an embodiment.

Referring to FIG. 10, operations S1010 to S1050 may be performed by a device (hereinafter, referred to as an external device) outside an electronic device (for example, the electronic device 10 of FIG. 4). However, the disclosure is not necessarily limited thereto. For example, the reference secondary path, a first optimal filtering set value, and a second optimal filtering set value generated in operations S1010 to S1050 may be stored in a memory (for example, the memory 600 of FIG. 4). Hereinafter, it is assumed that operations S1010 to S1050 are performed by the external device.

In operation S1010, the external device may obtain sample secondary paths. The sample secondary paths may indicate secondary paths obtained through a test. For example, the sample secondary paths may be the secondary path obtained from a plurality of sample users. For example, the sample secondary path of a first sample user may be a first sample secondary path, and the sample secondary path of a second sample user may be a second sample secondary path.

According to an embodiment, the external device may further obtain the sample secondary paths and a sample error signal and a sample noise signal corresponding to each of the sample secondary paths. The sample error signal and the sample noise signal may be used to calculate the optimal filtering set value set. For example, the sample error signal and the sample noise signal may be used in operation S1050. The sample error signal and the sample noise signal may be obtained based on the sample users.

In operation S1020, the external device may cluster the sample secondary paths. The number of clusters may be pre-set. Shapes of frequency response amplitudes of the sample secondary paths included in the same cluster may be substantially the same as each other. According to an embodiment, each of the clusters may be generated by clustering the plurality of sample secondary paths based on the shape of the frequency response amplitude of each of the plurality of sample secondary paths. For example, the plurality of sample secondary paths may be clustered into five clusters.

The external device may generate the clusters by clustering the plurality of sample secondary paths based on the shape of the frequency response amplitude of each of the plurality of sample secondary paths. The sample secondary paths having frequency response amplitudes having substantially the same shapes may be clustered. A sample error indicating the difference of the shape of the frequency response amplitude between the sample secondary paths included in the cluster may be calculated. Based on the sample error, the sample secondary paths may be clustered.

In operation S1030, the external device may obtain the reference secondary path. Each of the reference secondary paths may be an average value of the sample secondary paths included in each of the clusters respectively corresponding to the reference secondary paths. For example, a first reference secondary path may be an average value of the sample secondary paths included in a first cluster. A second reference secondary path may be an average value of the sample secondary paths included in a second cluster.

In operation S1040, the external device may obtain the first optimal filtering set value. The external device may obtain the first optimal filtering set value corresponding to each of the clusters. According to an embodiment, the first optimal filtering set value may be obtained by using at least one of a genetic algorithm and a Nelder-Mead method. However, the disclosure is not necessarily limited thereto and the first optimal filtering set value may be obtained by using various methods, such as deep learning, etc.

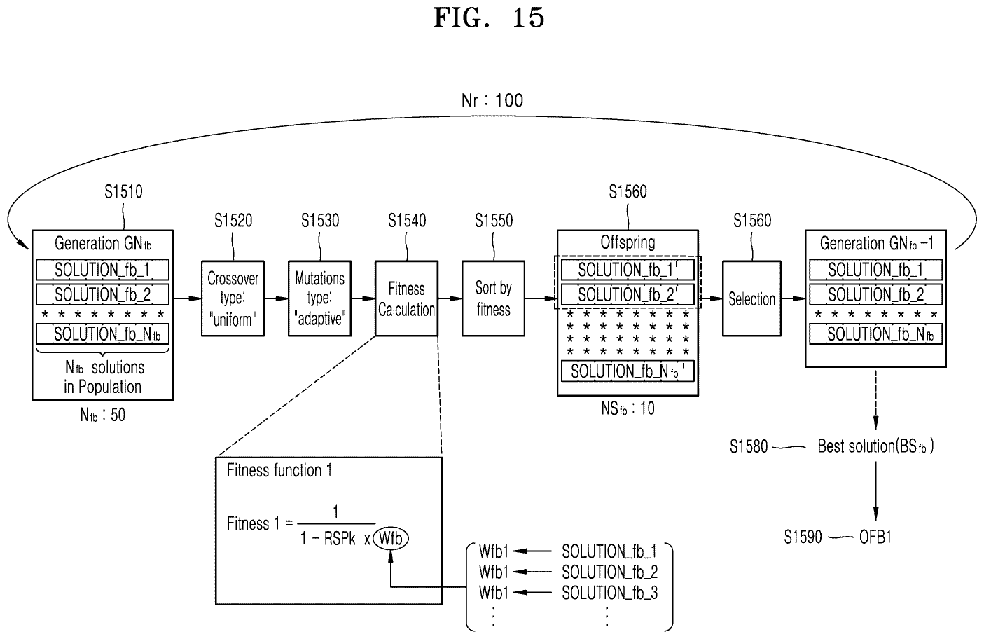

According to an embodiment, the first optimal filtering set value may be generated based on a first fitness function. To calculate the first fitness function, the reference secondary path corresponding to each cluster may be used. For example, to calculate the first fitness function for obtaining the first optimal filtering set value with respect to the first cluster, the first reference secondary path corresponding to the first cluster may be used. The first reference secondary path may be the average of the sample secondary paths included in the first cluster. For example, the first reference secondary path may be an average value of the frequency response amplitudes of the sample secondary paths included in the first cluster. A method of obtaining the first optimal filtering set value will be described in detail with reference to FIG. 15.

In operation S1050, the external device may obtain the second optimal filtering set value. The external device may obtain the second optimal filtering set value corresponding to each cluster. According to an embodiment, the second optimal filtering set value may be obtained by using at least one of a genetic algorithm and a Nelder-Mead method. However, the disclosure is not necessarily limited thereto and the second optimal filtering set value may be obtained by using various methods, such as deep learning, etc.

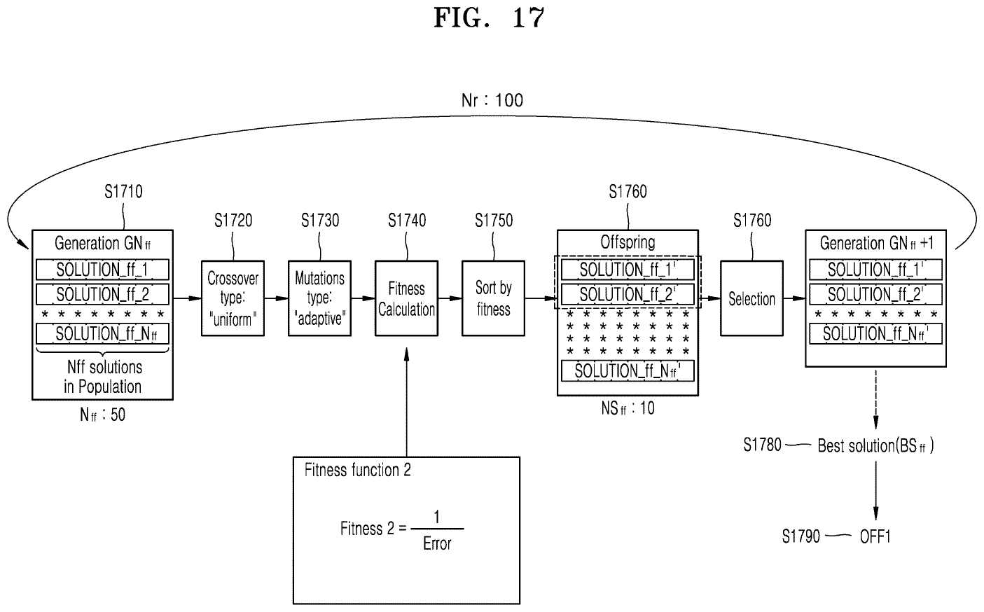

According to an embodiment, the second optimal filtering set value may be generated based on a second fitness function. The second fitness function may be different from the first fitness function. To calculate the second fitness function, the sample noise signal and the sample error signal corresponding to each of the sample secondary paths included in each cluster may be used. For example, to calculate the second fitness function for obtaining the second optimal filtering set value with respect to the first cluster, the sample noise signal and the sample error signal corresponding to each of the sample secondary paths included in the first cluster may be used. To calculate the second fitness function, the first reference secondary path corresponding to the first cluster may be used. A method of obtaining the second optimal filtering set value will be described in detail with reference to FIG. 17.

FIG. 11 is a view for describing a reference secondary path according to an embodiment. The same aspects as described above are omitted. Hereinafter, FIG. 6 is also referred to.

Referring to FIGS. 11 and 6, the reference secondary paths, namely, the first to fifth reference secondary paths RSP1 to RSP5, may correspond to the clusters, namely, the first to fifth clusters CL1 to CL5, respectively. For example, the first reference secondary path RSP1 may correspond to the first cluster CL1, the second reference secondary path RSP2 may correspond to the second cluster CL2, the third reference secondary path RSP3 may correspond to the third cluster CL3, the fourth reference secondary path RSP4 may correspond to the fourth cluster CL4, and the fifth reference secondary path RSP5 may correspond to the fifth cluster CL5. FIGS. 6 and 11 illustrate five clusters. However, the disclosure is not necessarily limited thereto and the number of clusters may be arbitrarily set.

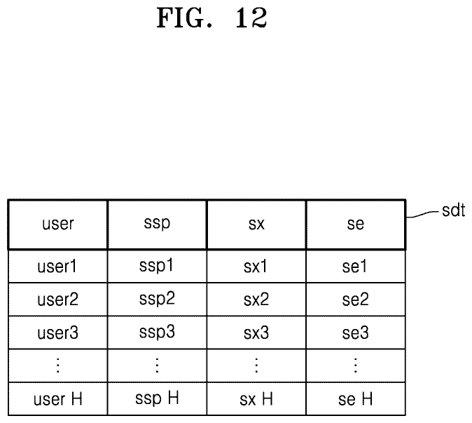

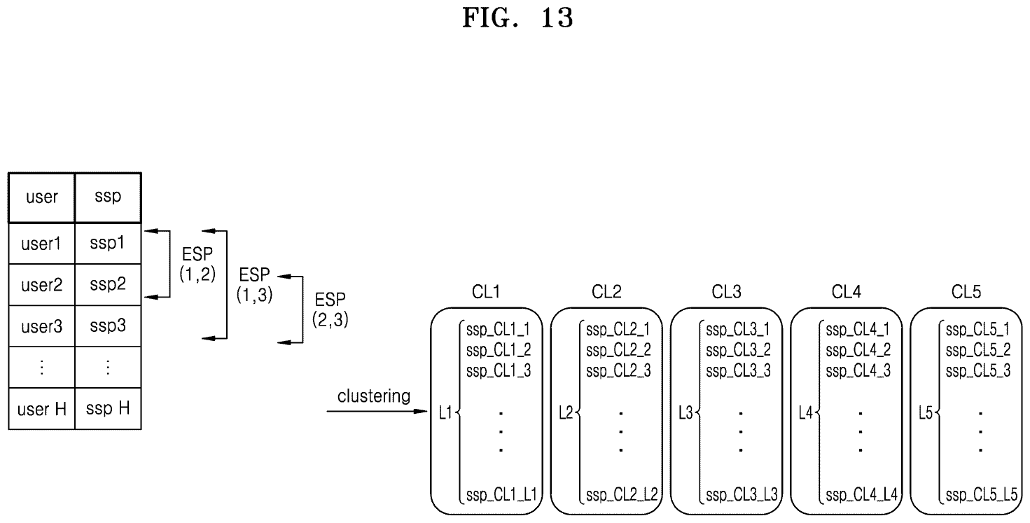

A device (hereinafter, referred to as an external device) outside an electronic device (for example, the electronic device 10 of FIG. 4) may calculate the first to fifth reference secondary paths RSP1 to RSP5 and store the first to fifth reference secondary paths RSP1 to RSP5 in the memory 600 of the electronic device (for example, the electronic device 10 of FIG. 4). For example, the external device may include an electronic device configured to generate the first to fifth clusters CL1 to CL5 by clustering a plurality of sample secondary paths ssp and calculate the first to fifth reference secondary paths RSP1 to RSP5 corresponding to the first to fifth clusters CL1 to CL5, respectively. Also, the external device may calculate the optimal filter set value sets, namely, the first to fifth optimal filter set value sets OFS1 to OFS5, corresponding to the first to fifth clusters CL1 to CL5, respectively. However, the disclosure is not necessarily limited thereto. The first to fifth reference secondary paths RSP1 to RSP5 and the first to fifth optimal filter set value sets OFS1 to OFS5 corresponding to the first to fifth clusters CL1 to CL5, respectively, may be obtained through a server. A method of clustering the plurality of sample secondary paths ssp will be described below with reference to FIGS. 12 and 13.

The plurality of sample secondary paths ssp may be clustered. The sample secondary paths ssp may indicate secondary paths obtained through a test. For example, the sample secondary paths may be the secondary paths obtained from a plurality of sample users. The number of clusters may be pre-set. Shapes of frequency response amplitudes of the sample secondary paths ssp included in the same cluster may be substantially or approximately the same as each other. For example, the sample secondary path ssp included in the first cluster CL1 may be a first cluster sample secondary path ssp_CL1_1. The first cluster CL1 may include L1 first cluster sample secondary paths ssp_CL1_1 to ssp_CL1_L1. The sample secondary path ssp included in the second cluster CL2 may be a second cluster sample secondary path ssp_CL2. The second cluster CL2 may include L2 second cluster sample secondary paths ssp_CL2_1 to ssp_CL2_L2. The sample secondary path ssp included in the third cluster CL3 may be a third cluster sample secondary path ssp_CL3. The third cluster CL3 may include L3 third cluster sample secondary paths ssp_CL3_1 to ssp_CL3_L3. The sample secondary path ssp included in the fourth cluster CL4 may be a fourth cluster sample secondary path ssp_CL4. The fourth cluster CL4 may include L4 fourth cluster sample secondary paths ssp_CL4_1 to ssp_CL4_L4. The sample secondary path ssp included in the fifth cluster CL5 may be a fifth cluster sample secondary path ssp_CL5. The fifth cluster CL5 may include L5 fifth cluster sample secondary paths ssp_CL5_1 to ssp_CL5_L5.

According to an embodiment, each of the first to fifth reference secondary paths RSP1 to RSP5 may be an average value of the sample secondary paths ssp included in each of the first to fifth clusters CL1 to CL5 corresponding to the first to fifth reference secondary paths RSP1 to RSP5, respectively. For example, the first reference secondary path RSP1 may be the average value of the L1 first cluster sample secondary paths ssp1_CL1_1 to ssp_CL1_L1 included in the first cluster CL1. The second reference secondary path RSP2 may be the average value of the L2 second cluster sample secondary paths ssp_CL2_1 to ssp_CL2_L2 included in the second cluster CL2. The third reference secondary path RSP3 may be the average value of the L3 third cluster sample secondary paths ssp_CL3_1 to ssp_CL3_L3 included in the third cluster CL3. The fourth reference secondary path RSP4 may be the average value of the L4 fourth cluster sample secondary paths ssp_CL4_1 to ssp_CL4_L4 included in the fourth cluster CL4. The fifth reference secondary path RSP5 may be the average value of the L5 fifth cluster sample secondary paths ssp_CL5_1 to ssp_CL5_L5 included in the fifth cluster CL5. For example, each of the first to fifth reference secondary paths RSP1 to RSP5 may be an average value of the frequency response amplitudes of the sample secondary paths ssp included in each of the first to fifth clusters CL1 to CL5 corresponding to the first to fifth reference secondary paths RSP1 to RSP5, respectively.

The first to fifth reference secondary paths RSP1 to RSP5 may be stored in the memory 600. The optimal filter set value set OFS corresponding to each of the first to fifth reference secondary paths RSP1 to RSP5 may be stored in the memory 600. A method of obtaining the optimal filter set value set OFS will be described below with reference to FIGS. 15 and 17.

FIG. 12 is a view for describing a sample secondary path ssp according to an embodiment. The sample secondary path ssp described with reference to FIG. 11 may correspond to the sample secondary path ssp in FIG. 12. The same aspects as described above are omitted.

Referring to FIG. 12, sample data sdt may include the sample secondary path ssp. The sample secondary path ssp may indicate a secondary path obtained through a test. For example, the sample secondary path ssp may be obtained from a plurality of sample users. For example, the sample secondary path ssp may be obtained from H sample users. The sample secondary path ssp of a first sample user user1 may be a first sample secondary path ssp1, the sample secondary path ssp of a second sample user user2 may be a second sample secondary path ssp2, the sample secondary path ssp of a third sample user user3 may be a third sample secondary path ssp3, and the sample secondary path ssp of an H^{th} sample user may be an H^{th} sample secondary path sspH. For example, the first sample secondary path ssp1, which is the sample secondary path ssp of the first sample user user1, may be included in a first cluster (for example, the first cluster CL1 of FIG. 11) and may correspond to the first cluster sample secondary path ssp_CL1_1. However, this aspect is only an example, for convenience of explanation.

The sample data sdt may further include a sample error signal se and a sample noise signal sx. The sample error signal se and the sample noise signal sx may be used to calculate an optimal filter set value set (for example, the optimal filter set value set OFS of FIG. 6). For example, the sample error signal se and the sample noise signal sx may be used to calculate a second optimal filtering set value. For example, the sample error signal se and the sample noise signal sx may be obtained based on the H sample users. The sample noise signal sx and the sample error signal se of the first sample user user1 may be a first sample noise signal sx1 and a first sample error signal se1, the sample noise signal sx and the sample error signal se of the second sample user user2 may be a second sample noise signal sx2 and a second sample error signal se2, the sample noise signal sx and the sample error signal se of the third sample user user3 may be a third sample noise signal sx3 and a third sample error signal se3, and the sample noise signal sx and the sample error signal se of the H^{th} sample user userH may be an H^{th} sample noise signal sxH and an H^{th} sample error signal scH.

FIG. 13 is a view for describing a method of clustering the sample secondary paths ssp, according to an embodiment. In FIG. 13, it is assumed that an external device outside an electronic device (for example, the electronic device 10 of FIG. 4) may cluster the plurality of sample secondary paths ssp.

According to an embodiment, each of the first to fifth clusters CL1 to CL5 may be formed by including the plurality of sample secondary paths ssp clustered based on the shapes of the frequency responses of the plurality of sample secondary paths ssp. FIG. 13 illustrates five clusters. However, the disclosure is not necessarily limited thereto and the number of clusters may be variously set.

The external device may cluster the sample secondary paths ssp according to the set number of clusters. The external device may cluster the sample secondary paths ssp according to the shape of the frequency response of each of the sample secondary paths and may generate the first to fifth clusters CL1 to CL5. The sample secondary paths ssp having substantially the same shape of the frequency response amplitude may be clustered together. A sample error ESP indicating the difference of the shape of the frequency response amplitude between the sample secondary paths ssp included in each of the clusters may be calculated. The sample secondary paths ssp may be clustered based on the sample error ESP.

The sample error ESP may be calculated for every pair of users. That is, the sample error ESP may be calculated with respect to all pairs of sample secondary paths ssp. First, the sample error ESP may be calculated by assuming that each of the sample secondary paths ssp corresponds to one cluster. For example, a sample error ESP(1,2) indicating the difference of the shape of the frequency response amplitude between the cluster of the first sample secondary path ssp1 and the cluster of the second sample secondary path ssp2 may be calculated. A sample error ESP(1,3) between the cluster of the first sample secondary path ssp1 and the cluster of the third sample secondary path ssp3 may be calculated. A sample error ESP(2,3) between the cluster of the second sample secondary path ssp2 and the cluster of the third sample secondary path ssp3 may be calculated. The sample error ESP may be calculated by Equation 2 below.

$$ESPa , b = ( Kincl \times ESPincl ( a , b ) ) + ( Kdist \times ESPdist ( a , b ) ) \qquad [ Equation 2 ]$$

Here, a may indicate one cluster or one sample secondary path ssp with respect to which the sample error ESP is to be calculated, and b may indicate another cluster or another sample secondary path ssp. ESPincl may indicate a sample cluster error, ESPdist may indicate a sample distance error, Kincl may indicate a weight of the sample cluster error, and Kdist may indicate a weight of the sample distance error.

The sample cluster error ESPincl may indicate a difference of the shape of the frequency response amplitude of the sample secondary path ssp. For example, when the sample secondary path ssp has the same frequency response amplitude, the sample cluster error ESPincl may be 0. The sample cluster error ESPincl may be calculated by Equation 3 below.

$$ESPincl ( a , b ) = {\sum }_{k = 1}^{Nk} ( {\sum }_{u = 1}^{uk} ( {( {Assp}_{k} ( f ) - {ssp}_{u , k} ( f ) )}^{2} ) \qquad [ Equation 3 ]$$

Here, k may indicate a certain cluster, Nk may indicate the number of clusters, u may indicate the sample secondary path (a sample secondary path corresponding to a user u), uk may indicate the number of sample secondary paths (the number of users) in the k^{th} cluster, Asspₖ may indicate an average of the frequency response amplitudes of all of the sample secondary paths included in the k^{th} cluster, and ssp_{u,k} may indicate the frequency response amplitude of the sample secondary path corresponding to the user u in the k^{th} cluster.

The sample cluster error ESPincl may indicate a difference of the shape of the frequency response amplitude of the sample secondary path ssp. For example, when the sample secondary path ssp has the same frequency response amplitude, the sample cluster error ESPincl may be 0.

The sample distance error ESPdist may be calculated by Equation 4 below.

$$ESPdist ( a , b ) = {\sum }_{a = 1}^{ua} ( {\sum }_{b = 1}^{ub} {( \frac{1}{{Assp}_{a} ( f ) - {Assp}_{b} ( f )} )}^{2} \qquad [ Equation 4 ]$$

Here, a may indicate one cluster or one sample secondary path ssp with respect to which the sample error ESP is to be calculated, b may indicate another cluster or another sample secondary path ssp, ua may indicate the number of sample secondary paths (the number of users) in the cluster a, ub may indicate the number of sample secondary paths (the number of users) in the cluster b, Asspₐ may indicate an average of the frequency response amplitudes of all of the sample secondary paths included in the cluster a, and the Assp_{b} may indicate an average of the frequency response amplitudes of all of the sample secondary paths in the cluster b.

The sample distance error ESPdist may indicate an error of the sample secondary path ssp corresponding to a user in the corresponding cluster, the user being in relation to a user in the other cluster. The sample distance error ESPdist may be a parameter for preventing two or more clusters from having substantially the same shape of the frequency response amplitudes.

The external device may search for a pair having the least sample error ESP. For example, when, from among all of the sample errors ESP, the sample error ESP(2,3) between the second sample secondary path ssp2 and the third sample secondary path ssp3 is the least, the second sample secondary path ssp2 and the third sample secondary path ssp3 may be arranged in one cluster, and an average of the second sample secondary path ssp2 and the third sample secondary path ssp3 may become the sample secondary path of the corresponding cluster. Thereafter, the external device may search for the pair having the least sample error ESP again and may repeat this process until a plurality of sample secondary paths ssp are clustered into a pre-set number of clusters.

For example, when the pre-set number of clusters is 5, the plurality of sample secondary paths ssp may be clustered into the first cluster CL1 to the fifth cluster CL5. For example, the second sample secondary path ssp2 and the third sample secondary path ssp3 may be included in the second cluster CL2 and may respectively correspond to the second cluster sample secondary path ssp_CL2_1 and the second cluster sample secondary path ssp_CL2_2. The number of sample secondary paths ssp included in each of the first to fifth clusters CL1 to CL5 may be different from each other. For example, the second cluster CL2 may include L2 sample secondary paths ssp and the third cluster CL3 may include L3 sample secondary paths ssp. L2 and L3 may be different positive integers. However, the disclosure is not necessarily limited thereto and L2 and L3 may be the same positive integers.

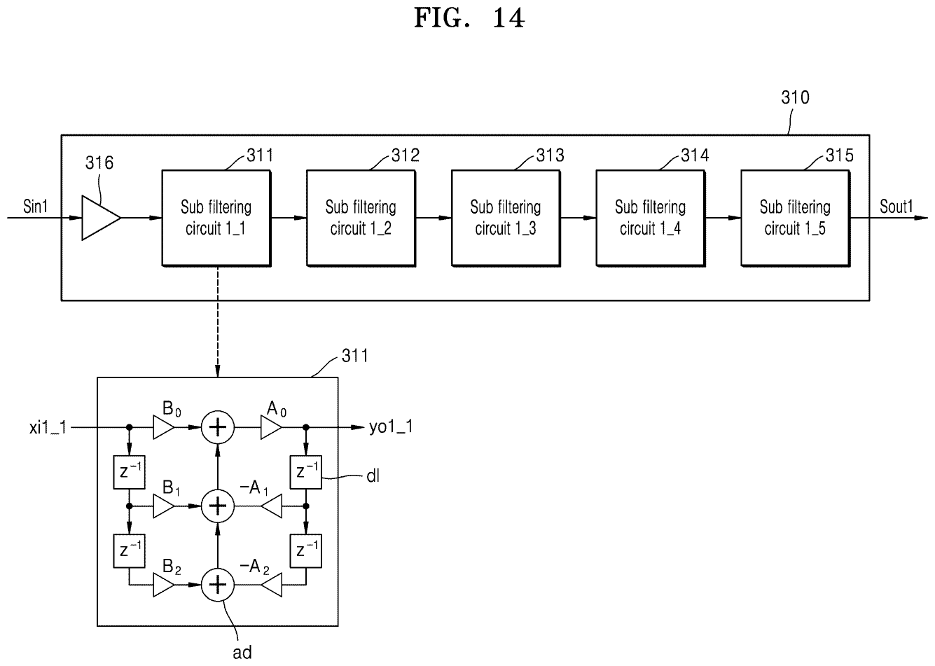

FIG. 14 is a view for describing the first filtering circuit 310 according to an embodiment. The first filtering circuit 310 of FIG. 14 may correspond to the first filtering circuit 310 of FIG. 4. The same aspects as described above are omitted.

Referring to FIG. 14, the first filtering circuit 310 may receive a first input signal Sin1 and output a first output signal Sout1. For example, the first input signal Sin1 may be an error signal (for example, the error signal e(n) of FIG. 4) and the first output signal Sout1 may be a first offset signal (for example, the first offset signal y1(n) of FIG. 4.

The first filtering circuit 310 may include a total gain 316 and a plurality of sub-filtering circuits, namely, first to fifth sub-filtering circuits 311 to 315. For example, the first filtering circuit 310 may include the first sub-filtering circuit 311, the second sub-filtering circuit 312, the third sub-filtering circuit 313, the fourth sub-filtering circuit 314, and the fifth sub-filtering circuit 315. FIG. 14 illustrates that the first filtering circuit 310 may include the five sub-filtering circuits 311 to 315. However, the disclosure is not necessarily limited thereto. The first filtering circuit 310 may include various numbers of sub-filtering circuits.

Each of the first to fifth sub-filtering circuits 311 to 315 may include at least one of a peaking filter, a low-shelf filter, and a high-shelf filter. The peaking filter may denote a filter amplifying or decreasing a certain frequency, the low-shelf filter may denote a filter adjusting a gain of a low band portion, and the high-shelf filter may denote a filter adjusting a gain of a high band portion. For example, the first sub-filtering circuit 311 may be the low-shelf filter, the second sub-filtering circuit 312 may be the peaking filter, the third sub-filtering circuit 313 may be the peaking filter, the fourth sub-filtering circuit 314 may be the peaking filter, and the fifth sub-filtering circuit 315 may be the peaking filter. However, the disclosure is not necessarily limited thereto.

Each of the first to fifth sub-filtering circuits 311 to 315 may be designed based on filter coefficients. For example, the first sub-filtering circuit 311 may include first filter coefficients, the second sub-filtering circuit 312 may include second filter coefficients, the third sub-filtering circuit 313 may include third filter coefficients, the fourth sub-filtering circuit 314 may include fourth filter coefficients, and the fifth sub-filtering circuit 315 may include fifth filter coefficients. A set value of the first filtering circuit 310 may indicate the total gain 316 and the filter coefficients for designing the first to fifth sub-filtering circuits 311 to 315, the total gain 316 and the first to fifth sub-filtering circuits 311 to 315 being included in the first filtering circuit 310. The set value of the first filtering circuit 310 may include the total gain 316 of the first filtering circuit 310, the first filter coefficients, the second filter coefficients, the third filter coefficients, the fourth filter coefficients, and the fifth filter coefficients.

For example, each of the first to fifth sub-filtering circuits 311 to 315 may be formed as a second order section filter. For example, the first sub-filtering circuit 311 may receive an input signal xi1_1 and output an output signal yo1_1. The first sub-filtering circuit 311 may include a delay device d1, an adder ad, first coefficients A0, A1, and A2, and second coefficients B0, B1, and B2. However, the disclosure is not necessarily limited thereto. The first coefficients A0, A1, and A2 and the second coefficients B0, B1, and B2 included in the first sub-filtering circuit 311 may be the first filter coefficients. Although not shown in FIG. 14, each of the second sub-filtering circuit 312 to the fifth sub-filtering circuit 315 may have the same or substantially the same structure as the first sub-filtering circuit 311.

A noise processing circuit (for example, the noise processing circuit 500 of FIG. 4) may adjust the set value of the filtering circuit 310. To adjust the set value of the first filtering circuit 310 may denote to adjust the filter coefficients of the first filtering circuit 310. For example, the set value of the first filtering circuit 310 may include the total gain 316 of the first filtering circuit 310, the first filter coefficients, the second filter coefficients, the third filter coefficients, the fourth filter coefficients, and the fifth filter coefficients.

Optimal filter set value sets (for example, the optimal filter set value sets OFS of FIG. 6) respectively corresponding to clusters (for example, the first to fifth clusters CL1 to CL5 of FIG. 6) may be stored in the memory 600. A first optimal filtering set value (for example, the first optimal filtering set value OFB of FIG. 6) corresponding to each of the first to fifth clusters CL1 to CL5 may be stored in the memory 600. For example, the first optimal filtering set value OFB may be obtained by an external device and stored in the memory 600. The first optimal filtering set value OFB corresponding to each cluster may denote a set value for optimizing, with respect to the first filtering circuit 310, the sample secondary paths included in each cluster.

The noise processing circuit 500 may change the set value of the first filtering circuit 310 based on the first optimal filtering set value OFB included in a selected optimal filter set value set. For example, the total gain 316, the first filter coefficients, the second filter coefficients, the third filter coefficients, the fourth filter coefficients, and the fifth filter coefficients of the first filtering circuit 310 may be changed as the selected first optimal filtering set value OFB. The first optimal filtering set value OFB may include the total gain 316 with respect to the first filtering circuit 310 and the filter coefficients. However, the disclosure is not necessarily limited thereto, and the first optimal filtering set value OFB may be a parameter, etc. for adjusting the total gain 316 with respect to the first filtering circuit 310 and the filter coefficients.

According to an embodiment, the first optimal filtering set value OFB may be obtained by using at least one of a genetic algorithm and a Nelder-Mead method. By searching for a cluster approximately or substantially the same as an object secondary path and using the first optimal filtering set value OFB corresponding to the corresponding cluster, the first filtering circuit 310 may be adjusted. Thus, the first filtering circuit 310 may be adjusted to be appropriate for a user, while the battery consumption is being reduced. Hereinafter, by referring to FIG. 15, the method of obtaining the first optimal filtering set value OFB is described.

FIG. 15 is a view for describing a method of generating a first optimal filtering set value OFB1, according to an embodiment. The same aspects as described above are omitted.

According to an embodiment, a device (hereinafter, referred to as an external device) outside an electronic device (for example, the electronic device 10 of FIG. 4) may calculate optimal filter set value sets (for example, the optimal filter set value sets OFS of FIG. 6) respectively corresponding to clusters (for example, the first to fifth clusters CL1 to CL5 of FIG. 6). However, the disclosure is not necessarily limited thereto. With reference to FIG. 15, the method of obtaining the first optimal filtering set value OFB1 corresponding to a first cluster (for example, the first cluster CL1 of FIG. 6) is described. With respect to other clusters, the first optimal filtering set value corresponding to each of the other clusters may also be obtained by using the method described with reference to FIG. 15.

According to an embodiment, the first optimal filtering set value OFB1 may be obtained by using at least one of a genetic algorithm and a Nelder-Mead method. However, the disclosure is not necessarily limited thereto and the first optimal filtering set value OFB1 may be obtained by using various methods, such as deep learning, etc. Referring to FIG. 15, an optimal solution BS_{fb} may be obtained by using the genetic algorithm and the Nelder-Mead method, and the first optimal filtering set value OFB1 may be obtained based on the optimal solution BStb.

A solution may indicate parameters for generating set values of a filtering circuit. The total gain of the filtering circuit and filter coefficients may be generated based on the solution. For example, the solution may include a plurality of parameters. The total gain of the filtering circuit may be generated based on at least some of the plurality of parameters included in the solution. The filter coefficients may be generated based on at least some of the plurality of parameters included in the solution. For example, the solution may include 16 parameters. The total gain of a first filtering circuit (for example, the first filtering circuit 310 of FIG. 14) may be generated based on a first parameter included in the solution. The coefficients (for example, the first coefficients A0, A1, and A2 and the second coefficients B0, B1, and B2 of FIG. 14) of the first filtering circuit 310 may be generated based on second to sixteenth parameters included in the solution. However, the disclosure is not necessarily limited thereto.

For example, the total gain of the first filtering circuit 310 and the filter coefficients may be generated based on the solution. The optimal solution BS_{fb} may indicate a parameter for generating the first optimal filtering set value OFB1 for optimizing sample secondary paths included in each cluster.

In operation S1510, solutions may be generated. For example, the solutions may be generated for generating the first optimal filtering set value OFB1 with respect to the first cluster CL1. The solutions may be randomly selected. The solutions may form a generation GN_{fb}. A set of the solutions may be referred to as the generation GN_{fb}. One generation GN_{fb} may include a plurality of solutions. The generation GN_{fb} may include N_{fb} (N_{fb} is a positive integer) solutions. For example, 50 solutions may be randomly generated. However, the number of solutions included in the generation GN_{fb} is not necessarily limited thereto. The N_{fb} solutions included in the generation GN_{fb} may be different from each other.

In operation S1520, a crossover operation may be performed. The number of solutions included in the generation GN_{fb} may be increased through the crossover operation. For example, the crossover operation may select two of the solutions included in the generation GN_{fb} and may generate a new solution by using the selected two solutions. In operation S1520, various crossover methods may be used. For example, a uniform crossover method may be used. However, the disclosure is not necessarily limited thereto.

In operation S1530, a mutation operation may be performed. The number of solutions included in the generation GN_{fb} may be increased through the mutation operation. For example, the mutation operation may randomly change some of the solutions included in the generation GN_{fb}. In operation S1530, various mutation methods may be used. For example, an adaptive mutation method may be used. However, the disclosure is not necessarily limited thereto. The number of solutions may be increased through operation S1520 and operation S1530.

In operation S1540, the fitness with respect to each solution may be calculated. A first fitness with respect to each solution may be calculated. According to an embodiment, the first optimal filtering set value OFB1 may be generated based on a first fitness function Fitness function 1. In detail, in order to obtain the first optimal filtering set value OFB1, the first fitness function may be applied to each solution and the fitness with respect to each solution may be calculated.

According to an embodiment, to calculate the first fitness function, a reference secondary path corresponding to each cluster may be used. For example, to calculate the first fitness function for obtaining the first optimal filtering set value OFB1 with respect to the first cluster CL1, a first reference secondary path (for example, the first reference secondary path RSP1 of FIG. 6) corresponding to the first cluster CL1 may be used. The first reference secondary path RSP1 may be the average of sample secondary paths included in the first cluster CL1. For example, the first reference secondary path RSP1 may be an average value of frequency response amplitudes of the sample secondary paths included in the first cluster CL1. To calculate the first fitness function with respect to the first cluster CL1, the average value of the sample secondary paths included in the first cluster CL1 may be used. The first fitness function may be represented by Equation 5 below.

$$Fitness 1 = \frac{1}{1 - ( RSPk \times Wfb )} \qquad [ Equation 5 ]$$

Here, RSPk may indicate the reference secondary path corresponding to a k^{th} cluster, that is, a k^{th} reference secondary path, and Wfb may indicate a transmission function of the first filtering circuit (for example, the first filtering circuit 310 of FIG. 14) designed based on each solution. The set value (for example, the filter coefficients) of the first filtering circuit 310 may be generated based on each solution, and the transmission function of the first filtering circuit 310 designed based on each solution may be generated.

For example, a first transmission function Wfb1 may be obtained based on a first solution solution_fb_1, and the first fitness corresponding to the first solution solution_fb_1 may be generated. A transmission function Wfb2 may be obtained based on a second solution solution_fb_2, and the first fitness corresponding to the second solution soltion_fb_2 may be generated. A transmission function Wfb3 may be obtained based on a third solution solution_fb_3, and the first fitness corresponding to the third solution solution_fb_3 may be generated.

In operation S1550, the solutions may be aligned based on the fitness. The solutions may be aligned based on the first fitness generated in operation S1540. For example, the solutions may be aligned according to the order of high first fitness.

In operation S1560, offspring may be generated. The offspring may be the solutions aligned based on the first fitness. For example, a solution SOLUTION_fb_1′ from the offspring may have the highest fitness, and a solution SOLUTION_fb_2′ may have a lower first fitness than the solution SOLUTION_fb_1′.

In operation S1570, some of the offspring may be selected. For example, some solutions of the offspring may be selected according to the order of high first fitness. NS_{fb} (NS_{fb} is a positive integer) solutions may be selected from among the solutions according to the order of high first fitness. For example, 10 solutions may be selected according to the order of high first fitness. The selected solutions may be transmitted to a next generation GN_{fb}+1. The next generation GN_{fb}+1 may be formed by including the solutions selected in operation S1570. For example, the next generation GN_{fb}+1 may randomly generate 50 solutions based on the selected solutions.

Operations S1510 to $1570 may be repeated a certain number of times. Operations S1510 to S1570 may be repeated a pre-set number of times Nr. For example, operations S1510 to S1570 may be repeated 100 times. After operations S1510 to S1570 are repeated the pre-set number of times Nr, the optimal solution BS_{fb} may be generated in operation S1580. For example, from among the solutions generated by repeating operations S1510 to S1570 the pre-set number of times Nr, a solution having the highest first fitness may be the optimal solution BStb. The first optimal filtering set value OFB1 may be generated based on the optimal solution BS_{fb} in operation S1590. The first optimal filtering set value OFB1 may be obtained from the optimal solution BStb with respect to the first cluster CL1. The first optimal filtering set value OFB1 may correspond to the first cluster CL1.

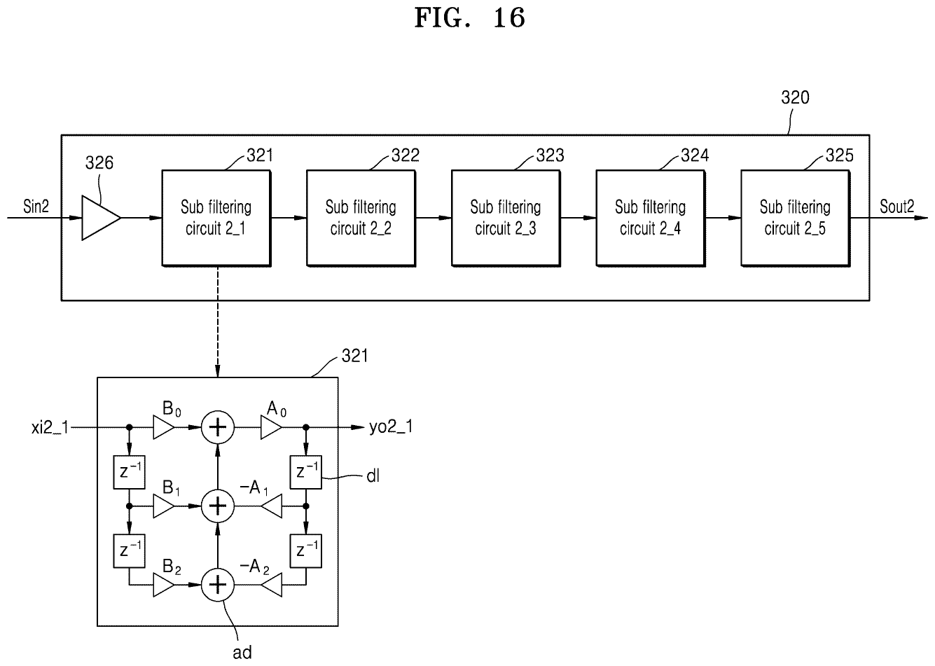

FIG. 16 is a view for describing the second filtering circuit 320 according to an embodiment. The second filtering circuit 320 of FIG. 16 may correspond to the second filtering circuit 320 of FIG. 4. For example, the second filtering circuit 320 of FIG. 16 may have substantially the same structure as the first filtering circuit 310 of FIG. 14. The second filtering circuit 320 and the first filtering circuit 310 may have substantially the same structure as each other, and the second filtering circuit 320 may include set values for reducing a noise signal (for example, the noise signal x(n) of FIG. 4) and the first filtering circuit 310 may include set values for reducing an error signal (for example, the error signal e(n) of FIG. 4). However, the disclosure is not necessarily limited thereto. The same aspects as described above are omitted.

Referring to FIG. 16, the second filtering circuit 320 may receive a second input signal Sin2 and output a second output signal Sout2. For example, the second input signal Sin2 may be the noise signal x(n), and the second output signal Sout2 may be a second offset signal (for example, the second offset signal y2(n) of FIG. 4).

The second filtering circuit 320 may include a total gain 326 and a plurality of sub-filtering circuits, namely, first to fifth sub-filtering circuits 321 to 325. For example, the second filtering circuit 320 may include the first sub-filtering circuit 321, the second sub-filtering circuit 322, the third sub-filtering circuit 323, the fourth sub-filtering circuit 324, and the fifth sub-filtering circuit 325. FIG. 16 illustrates that the second filtering circuit 320 may include the five sub-filtering circuits 321 to 325. However, the disclosure is not necessarily limited thereto. The second filtering circuit 320 may include various numbers of sub-filtering circuits.

Each of the first to fifth sub-filtering circuits 321 to 325 may include at least one of a peaking filter, a low-shelf filter, and a high-shelf filter. For example, the first sub-filtering circuit 321 may be the low-shelf filter, the second sub-filtering circuit 322 may be the peaking filter, the third sub-filtering circuit 323 may be the peaking filter, the fourth sub-filtering circuit 324 may be the peaking filter, and the fifth sub-filtering circuit 325 may be the peaking filter. However, the disclosure is not necessarily limited to.

Each of the first to fifth sub-filtering circuits 321 to 325 may be designed based on filter coefficients. The set value of the second filtering circuit 320 may indicate the total gain 326 included in the second filtering circuit 320 and the filter coefficients for designing the first to fifth sub-filtering circuits 321 to 325. The set value of the second filtering circuit 320 may include the total gain 326 of the second filtering circuit 320, first filter coefficients, second filter coefficients, third filter coefficients, fourth filter coefficients, and fifth filter coefficients.

For example, each of the first to fifth sub-filtering circuits 321 to 325 may be formed as a second order section filter. For example, the first sub-filtering circuit 321 may receive an input signal xi2_1 and output an output signal yo2_1. Although not shown in FIG. 16, each of the second to fifth sub-filtering circuits 322 to 325 may have the same or substantially the same structure as the first sub-filtering circuit 311.

A noise processing circuit (for example, the noise processing circuit 500 of FIG. 4) may adjust the set value of the second filtering circuit 320. To adjust the set value of the second filtering circuit 320 may denote to adjust the filter coefficients of the second filtering circuit 320. For example, the set value of the second filtering circuit 320 may include the total gain 326 of the second filtering circuit 320, the first filter coefficients, the second filter coefficients, the third filter coefficients, the fourth filter coefficients, and the fifth filter coefficients.

A second optimal filtering set value (for example, the second optimal filtering set value OFF of FIG. 6) corresponding to each of first to fifth clusters CL1 to CL5 may be stored in a memory (for example, the memory 600 of FIG. 6). For example, the second optimal filtering set value OFF may be obtained by an external device and stored in the memory 600. The second optimal filtering set value OFF corresponding to each cluster may denote a set value for optimizing, with respect to the second filtering circuit 320, sample secondary paths included in each cluster.

The noise processing circuit 500 may change the set value of the second filtering circuit 320 based on the second optimal filtering set value OFF included in a selected optimal filter set value set. According to an embodiment, the second optimal filtering set value OFF may be obtained by using at least one of a genetic algorithm and a Nelder-Mead method.

FIG. 17 is a view for describing a method of generating a second optimal filtering set value OFF1, according to an embodiment. The method of generating the second optimal filtering set value OFF1 of FIG. 17 may be substantially the same as the method of generating the first optimal filtering set value OFB1 of FIG. 15. The same aspects as described with reference to FIG. 15 are omitted.

According to an embodiment, the second optimal filtering set value OFF1 may be obtained by using at least one of a genetic algorithm and a Nelder-Mead method. However, the disclosure is not necessarily limited thereto, and the second optimal filtering set value OFF1 may be obtained by using various methods such as deep learning, etc. Referring to FIG. 17, an optimal solution BS_{ff} may be searched for by using the genetic algorithm and the Nelder-Mead method, and the second optimal filtering set value OFF1 may be obtained based on the optimal solution BS_{ff}.

A total gain of a filtering circuit may be generated based on at least some of a plurality of parameters included in a solution. Filter coefficients may be generated based on at least some of the plurality of parameters. For example, the solution may include 16 parameters. The total gain of a second filtering circuit (for example, the second filtering circuit 320 of FIG. 16) may be generated based on a first parameter included in the solution. The coefficients (for example, the first coefficients A0, A1, and A2 and the second coefficients B0, B1, and B2 of FIG. 16) of the second filtering circuit 320 may be generated based on second to sixteenth parameters included in the solution. However, the disclosure is not necessarily limited thereto.

For example, the total gain of the second filtering circuit 320 and the filter coefficients may be generated based on the solution. The optimal solution BS_{ff} may indicate a parameter for generating the second optimal filtering set value OFF1 for optimizing sample secondary paths included in each cluster. With reference to FIG. 17, the method of obtaining the second optimal filtering set value OFF1 corresponding to a first cluster (for example, the first cluster CL1 of FIG. 6) is described. With respect to other clusters, the second optimal filtering set value corresponding to each of the other clusters may be obtained by using the method described with reference to FIG. 17.

In operation S1710, solutions may be generated. For example, the solutions may be generated for generating the second optimal filtering set value OFF1 with respect to the first cluster CL1. The solutions may form a generation GN_{ff}. The generation GN_{ff} may include N_{ff} (N_{ff} is a positive integer) solutions.

In operation S1720, a crossover operation may be performed. The number of solutions included in the generation GN_{ff} may be increased through the crossover operation.

In operation S1730, a mutation operation may be performed. The number of solutions included in the generation GN_{ff} may be increased through the mutation operation.

In operation S1740, the fitness with respect to each of the solutions may be calculated. A second fitness with respect to each of the solutions may be calculated. According to an embodiment, second first optimal filtering set value OFF1 may be generated based on a second fitness function Fitness function 2. In detail, in order to obtain the second optimal filtering set value OFF1, the second fitness function may be applied to each solution and the fitness with respect to each solution may be calculated. The second fitness function may be different from the first fitness function.

According to an embodiment, to calculate the second fitness function Fitness function 2, a sample noise signal (for example, the sample noise signal sx of FIG. 12) and a sample error signal (for example, the sample error signal se of FIG. 12) corresponding to each of sample secondary paths (for example, the sample secondary paths ssp of FIG. 12) included in each cluster may be used. For example, to calculate the second fitness function Fitness function 2 for obtaining the second optimal filtering set value OFF1 with respect to the first cluster CL1, the sample noise signal sx and the sample error signal se corresponding to each of the sample secondary paths ssp included in the first cluster CL1 may be used.

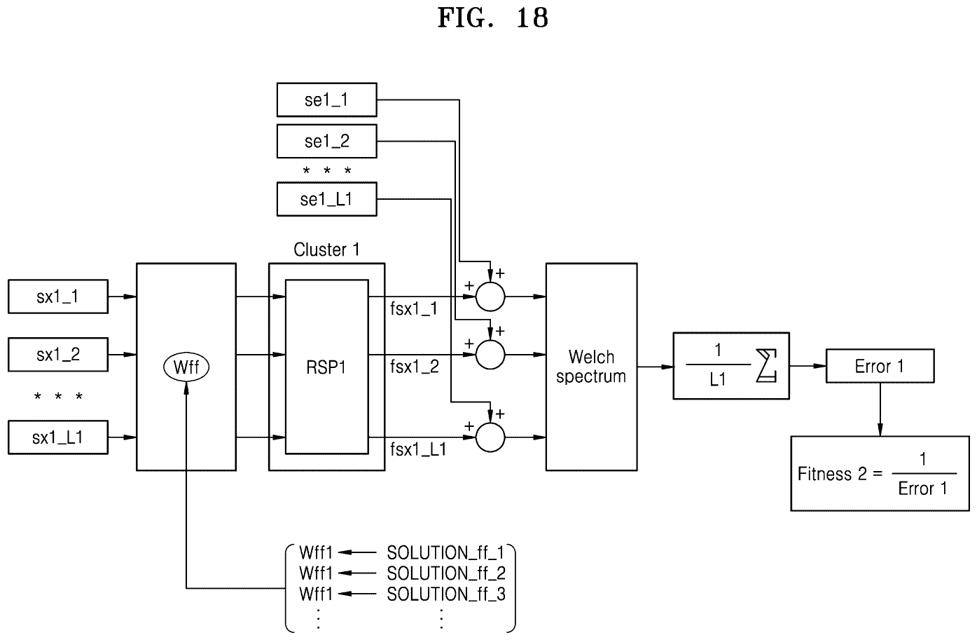

For example, the second fitness corresponding to a first solution SOLUTION_ff_1 may be generated based on the second fitness function Fitness function 2 and the first solution SOLUTION_ff_1. The second fitness corresponding to a second solution SOLUTION_ff_2 may be generated based on the second fitness function Fitness function 2 and the second solution SOLUTION_ff_2. The second fitness corresponding to a third solution SOLUTION_ff_3 may be generated based on the second fitness function Fitness function 2 and the third solution SOLUTION_ff_3. Aspects with respect to the second fitness function Fitness function 2 will be described in detail below with reference to FIG. 18.

In operation S1750, the solutions may be aligned based on the fitness. For example, the solutions may be aligned according to the order of high second fitness.

In operation S1760, offspring may be generated. The offspring may be the solutions aligned based on the second fitness. For example, in the offspring, a solution SOLUTION_ff_1′ may have the highest second fitness, and a solution SOLUTION_ff_2′ may have a lower second fitness than the solution SOLUTION_ff_1′.

In operation S1770, some of the offspring may be selected. For example, some solutions of the offspring may be selected according to the order of high second fitness. NS_{ff} (NS_{ff} is a positive integer) solutions may be selected from among the solutions according to the order of high second fitness. A next generation GN_{ff}+1 may be formed by including the solutions selected in operation S1770. For example, the next generation GN_{ff}+1 may randomly generate 50 solutions based on the selected solutions.

Operations S1710 to S1770 may be repeated a pre-set number of times Nr. For example, operations S1710 to S1770 may be repeated 100 times. After operations S1710 to S1770 are repeated the pre-set number of times Nr, the optimal solution BS_{ff} may be generated in operation S1780. For example, from among the solutions generated by repeating operations S1710 to S1770 the pre-set number of times Nr, a solution having the highest second fitness may be the optimal solution BS_{ff}. The second optimal filtering set value OFF1 may be generated based on the optimal solution BS_{ff} in operation S1790.

FIG. 18 is a view for describing a second fitness function according to an embodiment. The same aspects as described with reference to FIG. 17 are omitted. Hereinafter, FIG. 17 is also referred to.

The second optimal filtering set value OFF1 may be generated based on the second fitness function. In detail, in order to obtain the second optimal filtering set value OFF1, the second fitness function may be applied to each of solutions and the fitness with respect to each solution may be calculated.

To calculate the second fitness function, a sample noise signal (for example, the sample noise signal sx of FIG. 12) and a sample error signal (for example, the sample error signal se of FIG. 12) corresponding to each of sample secondary paths (for example, the sample secondary paths ssp of FIG. 12) included in each cluster may be used. For example, to calculate the second fitness function for obtaining the second optimal filtering set value OFF1 with respect to the first cluster CL1, a sample noise signal sx1 and a sample error signal se1 corresponding to each of the sample secondary paths ssp included in the first cluster CL1 may be used.

According to an embodiment, to calculate the second fitness function with respect to the first cluster CL1, the first reference secondary path RSP1 corresponding to the first cluster CL1 may be used. The first reference secondary path RSP1 may be the average of the sample secondary paths included in the first cluster CL1. To calculate the second fitness function with respect to the first cluster CL1, an average value of the sample secondary paths included in the first cluster CL1 may be used.

Referring to FIG. 18, filtering values fsx1_1 to fsx1_L1 may be generated by applying, to each of sample noise signals sx1_1 to sx1_L1, a transmission function Wff of a second filtering circuit, to which the first solution SOLUTION_ff_1 is applied, and the first reference secondary path RSP1. Each of the sample noise signals sx1_1 to sx1_L1 may indicate the sample noise signal sx corresponding to each of first cluster sample secondary paths included in the first cluster CL1.

A Welch spectrum may be applied to the summation of each of the filtering values fsx1_1 to fsx1_L1 and each of sample error signals se1_1 to se1_L1 respectively corresponding to the filtering values fsx1_1 to fsx1_L1, and an average value thereof may be obtained to obtain a first error Error1 with respect to the first solution SOLUTION_ff_1. Each of the sample error signals se1_1 to se1_L1 may denote the sample error signal se corresponding to each of the first cluster sample secondary paths included in the first cluster CL1. The second fitness with respect to the first solution SOLUTION_ff_1 may be generated by calculating an inverse number of the first error Error1. The second fitness function may be represented by Equation 6 below.

$$Fitness 2 = \frac{1}{Error 1} \qquad [ Equation 6 ]$$

$$Error 1 = Welch ( {\sum }_{Nssp 1 = 1}^{L 1} ( se {1}_{Nssp 1} - Wff ( RSP 1 ( sx {1}_{Nssp 1} ) ) ) )$$

Here, RSP1 may indicate the reference secondary path corresponding to the first cluster, that is, the first reference secondary path, and Wff may indicate the transmission function of the second filtering circuit (for example, the second filtering circuit 320 of FIG. 16) designed based on each solution. Nₛₛₚ₁ may indicate the sample path included in the first cluster, se1_{Nssp1} may indicate the sample error signal corresponding to the certain sample path Nₛₛₚ₁, sx1_{Nssp1} may indicate the sample noise signal corresponding to the certain sample path Nₛₛₚ₁, and L1 may indicate the number of sample paths included in the first cluster.

For example, similarly to the method of obtaining the second fitness with respect to the first solution SOLUTION_ff_1, a transmission function Wff2 may be obtained based on the second solution SOLUTION_ff_2. The first error Error1 with respect to the second solution SOLUTION_ff_2 may be obtained based on the transmission function Wff2, and the second fitness may be generated with respect to the second solution SOLUTION_ff_2.

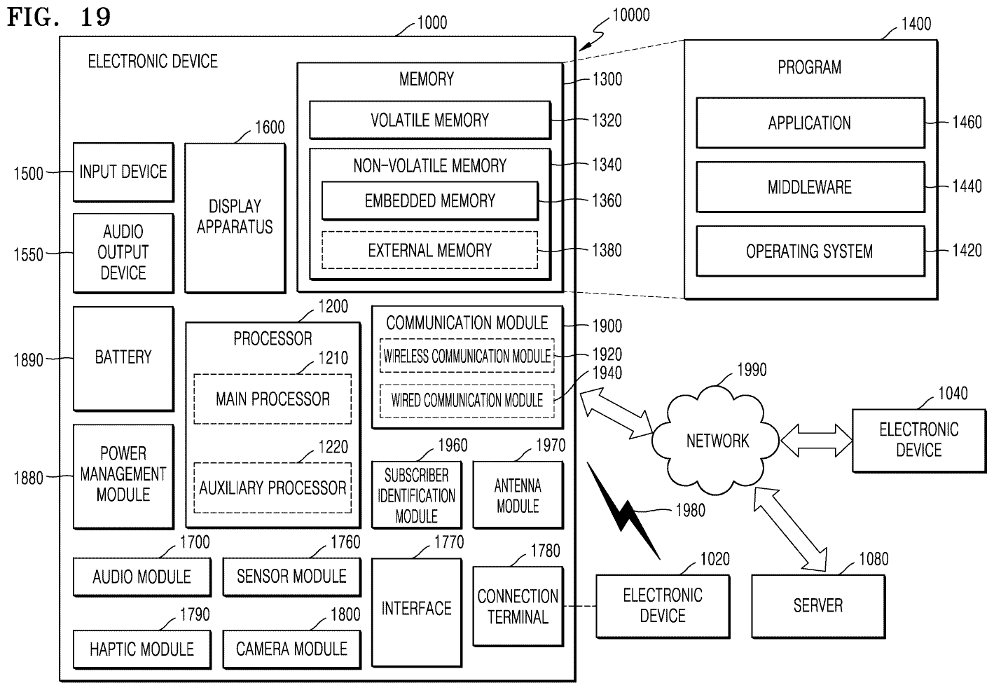

FIG. 19 is a block diagram of an electronic device 1000 according to an embodiment. The electronic device 10 of FIG. 1 may be included in the electronic device 1000 of FIG. 19. The same aspects as described above are omitted.

FIG. 19 illustrates the electronic device 1000 in a network environment 10000. According to various embodiments, the electronic device 1000 may include an ear-wearable device. The electronic device 1000 may communicate with an electronic device 1020 (for example, an external electronic device) through a first network 1980 (for example, a short-range wireless communication network) or may communicate with an electronic device 1040 (for example, an external electronic device) or a server 1080 through a second network 1990 (for example, a remote wireless communication network). According to an embodiment, the electronic device 1000 may communicate with the electronic device 1040 through the server 1080. According to an embodiment, the electronic device 1000 may include a processor 1200, a memory 1300, an input device 1500, a sound output device 1550, a display device 1600, an audio module 1700, a sensor module 1760, an interface 1770, a haptic module 1790, a camera module 1800, a power management module 1880, a battery 1890, a communication module 1900, a subscriber identification module 1960, or an antenna module 1970. According to some embodiments, the electronic device 1000 may omit at least one (for example, the display device 1600 or the camera module 1800) of these components or may further include one or more other components. According to some embodiments, some of these components may be realized as an integrated circuit. For example, the sensor module 1760 (for example, a fingerprint sensor, an iris sensor, or an illuminance sensor) may be embedded in the display device 1600 (for example, a display).

The processor 1200 may, for example, execute software (e.g., a program 1400) to control at least another component (e.g., a hardware or software component) of the electronic device 1000 connected to the processor 1200 and to perform various data processing or calculation operations. According to an embodiment, at least as part of the data processing or calculation operations, the processor 1200 may load a command or data received from the other components (e.g., the sensor module 1760 or the communication module 1900) in a volatile memory 1320, process the command or data stored in the volatile memory 1320, and store resultant data in a nonvolatile memory 1340. According to an embodiment, the processor 1200 may include a main processor 1210 (for example, a CPU and/or an AP) and/or an auxiliary processor 1220 (for example, a graphics processing unit (GPU), an image signal processor, a sensor hub processor, and/or a communication processor (CP)) operating separately from or together with the main processor 1210. Additionally or alternatively, the auxiliary processor 1220 may be set to use less power than the main processor 1210 or to be specialized in a designated function. The auxiliary processor 1220 may be realized separately from or as part of the main processor 1210.

For example, the auxiliary processor 1220 may control at least some of functions or states related to at least one component (e.g., the display device 1600, the sensor module 1760, and/or the communication module 1900) of the electronic device 1000, on behalf of the main processor 1210 when the main processor 1210 is in an inactive (e.g., sleep) state or together with the main processor 1210 when the main processor 1210 is in an active (e.g., application execution) state. According to an embodiment, the auxiliary processor 1220 (e.g., an image signal processor and/or a communication processor) may be realized as part of other functionally related components (e.g., the camera module 1800 and/or the communication module 1900).

The memory 1300 may store various data used by at least one component (e.g., the processor 1200 and/or the sensor module 1760) of the electronic device 1000. The data may include, for example, software (e.g., the program 1400) and input data or output data with respect to a command with respect to the software. The memory 1300 may include the volatile memory 1320 and/or the nonvolatile memory 1340.

The program 1400 may be stored in the memory 1300 as software and may include, for example, an operating system 1420, middleware 1440, and/or an application 1460.

The input device 1500 may receive, from the outside (e.g., a user) of the electronic device 1000, a command or data to be used with respect to the components (e.g., the processor 1200) of the electronic device 1000. The input device 1500 may include, for example, a microphone, a mouse, a keyboard, and/or a digital pen (e.g., a stylus pen). The input device 1500 may include a physical key configured to at least partially control the electronic device 1000. For example, the input device 1500 may include a volume key configured to control the volume of audio and a key configured to execute at least one program.

The sound output device 1550 may output a sound signal to the outside of the electronic device 1000. The sound output device 1550 may include, for example, a speaker and/or a receiver. The speaker may be used for a general purpose, such as multimedia reproduction or recording reproduction, and the receiver may be used to receive an incoming call. According to an embodiment, the receiver may be realized separately from or as part of the speaker.

The display device 1600 may visually provide information to the outside (e.g., a user) of the electronic device 1000. The display device 1600 may include, for example, a display, a hologram device, and/or a control circuit configured to control a projector and a corresponding device. According to an embodiment, the display device 1600 may include a touch circuit configured to sense a touch operation and/or a sensor circuit (e.g., a pressure sensor) configured to measure the intensity of a force generated by the touch operation.

The audio module 1700 may convert sound into an electrical signal or an electrical signal into sound, inversely. According to an embodiment, the audio module 1700 may obtain the sound through the input device 1500 or may output the sound through the sound output device 1550 and/or an external electronic device (e.g., the electronic device 1020 (e.g., a speaker or a headphone)) directly or wirelessly connected to the electronic device 1000. The electronic device 1020 may be an ear-wearable device (e.g., a headphone or earbud) such as depicted in FIG. 2 and as described in connection with the various embodiments disclosed herein.

The sensor module 1760 may sense an operating state (e.g., a power supply or a temperature) of the electronic device 1000 and/or an external environmental state (e.g., a user state) and may generate an electrical signal and/or a data value corresponding to the sensed state. According to an embodiment, the sensor module 1760 may include, for example, a gesture sensor, a gyro sensor, an atmospheric sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 1770 may support one or more predesignated protocols which may be used for the electronic device 1000 to be connected to an external electronic device (e.g., the electronic device 1020) in a wired or wireless fashion. According to an embodiment, the interface 1770 may include, for example, a high definition multimedia interface (HDMI), a universal serial bus (USB) interface, an SD card interface, and/or an audio interface.

A connection terminal 1780 may include a connector through which the electronic device 1000 may be physically connected to an external electronic device (e.g., the electronic device 1020). According to an embodiment, the connection terminal 1780 may include, for example, an HDMI connector, a USB connector, an SD card connector, and/or an audio connector (e.g., a headphone connector).

The haptic module 1790 may convert an electrical signal to a mechanical stimulus (e.g., vibration or motion) and/or an electrical stimulus which may be recognized by a user through a tactile sense or a kinesthetic sense. According to an embodiment, the haptic module 1790 may include, for example, a motor, a piezoelectric device, and/or an electrical stimulus device.

The camera module 1800 may capture a still image and/or a motion image. According to an embodiment, the camera module 1800 may include one or more lenses, image sensors, image signal processors, and/or flashes. According to an embodiment, the camera module 1800 may include a front camera arranged on a front surface of the electronic device 1000 and/or a rear camera arranged on a rear surface of the electronic device 1000.

The power management module 1880 may manage a power supply provided to the electronic device 1000. According to an embodiment, the power management module 1880 may be realized, for example, as at least a part of a power management integrated circuit (PMIC).

The battery 1890 may supply power to at least one component of the electronic device 1000. According to an embodiment, the battery 1890 may include, for example, a non-rechargeable primary battery, a rechargeable secondary battery, and/or a fuel battery.

The communication module 1900 may support the establishment of a direct (e.g., wired) communication channel or a wireless communication channel between the electronic device 100 and an external electronic device (e.g., the electronic device 1020, the electronic device 1040, and/or the server 1080) and/or the execution of communication through the established communication channel. The communication module 1900 may include one or more communication processors independently operating from the processor 1200 (e.g., an AP) and supporting direct (e.g., wired) communication or wireless communication. According to an embodiment, the communication module 1900 may include a wireless communication module 1920 (e.g., a cellular communication module, a short-range wireless communication module, and/or a global navigation satellite system (GNSS) communication module) and/or a wired communication module 1940 (e.g., a local area network (LAN) communication module and/or a power line communication module). A corresponding communication module from among these communication modules may communicate with the external electronic device through the first network 1980 (e.g., a short-range wireless communication network, such as Bluetooth, Wifi direct, or infrared data association (IrDA)) and/or the second network 1990 (e.g., a remote distance communication network, such as a cellular network, the Internet, and/or a computer network (e.g., a LAN or a wide area network (WAN))). Various types of these communication modules may be integrated into one component (e.g., a single chip) or may be realized as a plurality of different components (e.g., a plurality of chips). The wireless communication module 1920 may identify and authenticate the electronic device 1000 in a communication network such as the first network 1980 and/or the second network 1990, by using subscriber information (e.g., the international mobile subscriber identity (IMSI)) stored in the subscriber identification module 1960.

The antenna module 1970 may transmit a signal or a power supply to the outside (e.g., an external electronic device) or receive the signal or the power supply from the outside. According to an embodiment, the antenna module 1970 may include an antenna including a radiator formed of a conductor and/or a conductive pattern formed above a substrate (e.g., a printed circuit board (PCB)). According to an embodiment, the antenna module 1970 may include a plurality of antennas. In this case, at least one antenna appropriate for a communication method used in the communication network such as the first network 1980 and/or the second network 1990 may be selected, for example, by the communication module 1900, from among the plurality of antennas. The signal and/or the power supply may be transmitted or received between the communication module 1900 and the external electronic device through the at least one selected antenna. According to some embodiments, another component (for example, a radio frequency integrated circuit (RFIC)) in addition to the radiator may be additionally formed as part of the antenna module 1970.

At least some of the components described above may be connected to each other and may exchange signals (e.g., commands or data) through a method of communication between peripheral devices (e.g., a bus, general purpose input and output (GPIO), a serial peripheral interface (SPI), and/or a mobile industry processor interface (MIPI)).

According to an embodiment, the commands and/or the data may be transmitted or received between the electronic device 1000 and the external electronic device 1040 through the server 1080 connected to the second network 1990. Each of the external electronic devices 1020 and 1040 may be the same type of device as the electronic device 1000 or a different type of device from the electronic device 1000. According to an embodiment, all or part of operations executed by the electronic device 1000 may be executed by one or more external devices from among the external electronic devices 1020, 1040, and 1080. For example, when the electronic device 1000 has to execute a certain function or service automatically or in response to a request by a user or another device, the electronic device 1000 may not directly execute the function and/or service but may request one or more external electronic devices to execute at least a portion of the function and/or service, or the electronic device 1000 may directly execute the function and/or service and may additionally request one or more external electronic devices to execute at least a portion of the function and/or service. The one or more external electronic devices receiving the request may execute the requested at least the portion of the function or service or an additional function or service related to the request and may transmit a result of the execution to the electronic device 1000. The electronic device 1000 may provide the result as at least a part of the response to the request directly or may provide the result as at least a part of the response to the request by additionally processing the result. To this end, for example, a cloud computing, distributed computing, or client-server computing technique may be used.

While the inventive concept has been particularly shown and described with reference to example embodiments thereof, it will be understood that various changes in form and details may be made therein without departing from the spirit and scope of the following claims.

What is claimed is:

1. An electronic device comprising:
a first microphone configured to receive a noise signal;
a second microphone configured to receive an error signal and forming a primary path from the first microphone;
a filtering circuit configured to generate an electrical offset signal for offsetting at least one of the noise signal and the error signal;
a memory in which reference secondary paths and pre-set optimal filter set value sets corresponding to the reference secondary paths, respectively, are stored; and
a noise processing circuit configured to adjust a set value of the filtering circuit,
wherein the noise processing circuit is configured to:
estimate an object secondary path between an inner speaker outputting an acoustic offset signal corresponding to the electrical offset signal, and the second microphone,
select one of the optimal filter set value sets by comparing the estimated object secondary path with each of the reference secondary paths, and
change, based on the selected optimal filter set value set, the set value of the filtering circuit.

2. The electronic device of claim 1, wherein the noise processing circuit is configured to estimate the object secondary path, based on an inner sound signal and the error signal with respect to the inner sound signal, the error signal being received from the second microphone.

3. The electronic device of claim 1, wherein the noise processing circuit calculates a deviation between each of the reference secondary paths stored in the memory and the object secondary path and selects, from among the optimal filter set value sets, an optimal filter set value set corresponding to the reference secondary path for which the deviation is least.

4. The electronic device of claim 3, wherein the noise processing circuit is configured to calculate the deviation between each of the reference secondary paths and the object secondary path in a frequency domain between a first frequency and a second frequency.

5. The electronic device of claim 1, wherein:
the filtering circuit comprises:
a first filtering circuit configured to generate a first electrical offset signal for offsetting the error signal; and
a second filtering circuit configured to generate a second electrical offset signal for offsetting the noise signal.

6. The electronic device of claim 5, wherein:
each of the optimal filter set value sets comprises a first optimal filtering set value and a second optimal filtering set value, and
the noise processing circuit changes, based on the first optimal filtering set value being selected, a set value of the first filtering circuit, and changes, based on the second optimal filtering set value being selected, a set value of the second filtering circuit.

7. The electronic device of claim 1, wherein:
the reference secondary paths respectively correspond to clusters in each of which a plurality of sample secondary paths are clustered, and
each particular reference secondary path of the reference secondary paths is an average value of the sample secondary paths included in a cluster corresponding to the particular reference secondary path.

8. The electronic device of claim 7, wherein each of the clusters is generated by clustering the plurality of sample secondary paths, based on a shape of a frequency response of each of the plurality of sample secondary paths.

9. The electronic device of claim 7, wherein the optimal filter set value sets corresponding to the clusters, respectively, are generated by using at least one of a genetic algorithm and a Nelder-Mead method.

10. The electronic device of claim 9, wherein:
each of the optimal filter set value sets comprises a first optimal filtering set value and a second optimal filtering set value,
the first optimal filtering set value is generated based on a first fitness function, and
the second optimal filtering set value is generated based on a second fitness function which is different from the first fitness function.

11. The electronic device of claim 10, wherein:
the clusters comprise a first cluster, and
the first optimal filtering set value corresponding to the first cluster is generated based on the first fitness function using a first reference secondary path corresponding to the first cluster.

12. The electronic device of claim 11, wherein the second optimal filtering set value corresponding to the first cluster is generated based on the second fitness function using sample noise signals respectively corresponding to the sample secondary paths included in the first cluster and sample error signals respectively corresponding to the sample secondary paths included in the first cluster.

13. A noise processing circuit comprising:
a path estimator configured to receive an inner sound signal transmitted to an inner speaker and an error signal transmitted from an error microphone, and configured to estimate, based on the inner sound signal and the error signal, an object transmission path between the inner speaker and the error microphone; and
a set value adjustor configured to:
compare the estimated object transmission path with each of a plurality of reference transmission paths,
select, based on a result of the comparison, one filter set value set from among pre-set filter set value sets corresponding to the reference transmission paths, respectively, and
output a control signal for adjusting, based on the selected filter set value set, a set value of a filtering circuit.

14. The noise processing circuit of claim 13, wherein the set value adjustor obtains a difference between each reference path of the plurality of reference transmission paths and the object transmission path and selects, from among the pre-set filter set value sets, a filter set value set corresponding to the reference transmission path for which the difference from the object transmission path is least.

15. The noise processing circuit of claim 14, wherein the set value adjustor obtains the difference between each reference path of the plurality of reference transmission paths and the object transmission path, based on a frequency domain between a first frequency and a second frequency.

16. The noise processing circuit of claim 13, wherein:
the filtering circuit comprises a first filtering circuit and a second filtering circuit, and
the set value adjustor outputs a first control signal for adjusting, based on a first filtering set value included in the selected filter set value set, a set value of the first filtering circuit and outputs a second control signal for adjusting, based on a second filtering set value included in the selected filter set value set, a set value of the second filtering circuit.

17. The noise processing circuit of claim 13, wherein each particular reference transmission path of the reference transmission paths is an average value of a plurality of sample transmission paths included in a cluster respectively corresponding to the particular reference transmission path, and
each of the clusters is generated by clustering the plurality of sample transmission paths, based on a shape of a frequency response of each of the plurality of sample transmission paths.

18. The noise processing circuit of claim 17, wherein the filter set value sets corresponding to the clusters, respectively, are generated by using at least one of a genetic algorithm and a Nelder-Mead method.

19. The noise processing circuit of claim 18, wherein:
each of the filter set value sets comprises a first optimal filtering set value and a second filtering set value,
the first filtering set value is generated based on a corresponding reference transmission path, and
the second filtering set value is generated based on sample noise signals and sample error signals respectively corresponding to the sample transmission paths included in a corresponding cluster.

20. An operating method of a noise processing circuit, the operating method comprising:
receiving an inner sound signal transmitted through an inner speaker and an error signal transmitted from an error microphone;
estimating, based on the inner sound signal and the error signal, an object transmission path between the inner speaker and the error microphone;
comparing the estimated object transmission path with each of a plurality of reference transmission paths stored in a memory;
selecting, based on a result of the comparison, one filter set value set from among pre-set filter set value sets respectively corresponding to the reference transmission paths; and
adjusting, based on the selected filter set value set, a set value of a filtering circuit.
